(19) United States
(12) Patent Application Publication
(10) Pub. No.: US 2026/0204537 A1
(43) Pub. Date: Jul. 16, 2026

(54) TECHNIQUES FOR MAKING TWO-SIDED ELECTROCHEMICAL CELLS

(71) Applicant: Solid Power Operating, Inc., Louisville, CO (US)

(72) Inventors: Alexander DELLUVA, Boulder, CO (US); Brian E. FRANCISCO, Arvada, CO (US); David A. TELEP, Longmont, CO (US)

(21) Appl. No.: 18/528,639

(22) Filed: Dec. 4, 2023

Related U.S. Application Data
(60) Provisional application No. 63/429,751, filed on Dec. 2, 2022.
(60) Provisional application No. 63/457,089, filed on Apr. 4, 2023.

(51) Int. Cl. H01M 4/04; H01M 50/403

(52) U.S. Cl. CPC H01M 4/0404; H01M 50/403

(57) ABSTRACT

Described herein are processes for preparing electrochemical cells. The processes generally include simultaneously coating a top side and a bottom side of a two-sided surface with first and second wet electrode slurry, respectively; and simultaneously coating a first and second separator slurry on each of the respective top and bottom coated wet electrode slurry resulting in two parallel regions of wet-on-wet areas of contact between electrode and separator to physically form two neighboring electrochemical cell portions of a solid state battery.

### CROSS-REFERENCE TO RELATED APPLICATIONS

This application is related to and claims priority under 35 U.S.C. § 119(e) from U.S. Patent Application No. 63/457,089 filed Apr. 4, 2023, entitled “PROCESS FOR MAKING SOLID-STATE MULTILAYER ELECTROCHEMICAL CELL COMPONENTS HAVING BINDER CONCENTRATION GRADIENTS,” and to U.S. Patent Application No. 63/429,751 filed Dec. 2, 2022, entitled “SOLID-STATE ELECTRODES HAVING BINDER CONCENTRATION GRADIENTS AND METHODS OF MAKING THE SAME,” the entire contents of which are incorporated herein by reference for all purposes.

### TECHNICAL FIELD

The present disclosure relates to solid-state electrolyte materials including sulfide-based crystal phase composite materials. The disclosure therefore relates to the fields of chemistry, chemical engineering, and electrical engineering.

### BACKGROUND

Current production methods for solid-state batteries generally include assembling a negative electrode layer (anode), one or more separator layers (solid electrolyte layers), and a positive electrode layer (cathode). One or more of these layers may be pressed or laminated together to ensure optimal surface-to-surface contact between the layers, resulting in optimal electrochemical performance of the solid-state batteries.

Each layer is generally manufactured in a similar process, wherein the components of each layer are mixed with binders and solvents into a slurry, which is then cast/coated onto a carrier foil or a current collector. The slurry is then dried to remove the solvent, leaving behind a solid layer that can then be incorporated into an electrochemical cell.

The interfaces between each layer of the battery must have a high degree of surface-to-surface contact to ensure maximum performance. Generally, this is accomplished by increasing the amount of binder used in each layer. However, increasing the binder concentration also increases the overall ionic and electronic resistance of the cell because binders generally cannot conduct ions or electrons.

What is needed are methods of making electrochemical cells with high surface-to-surface contact between the layers of the cell and low electronic and ionic resistance.

### SUMMARY

Provided herein is a process for making two-sided electrochemical cells comprising: simultaneously coating a top side and a bottom side of a two-sided surface with first and second wet electrode slurry, respectively; and simultaneously coating a first and second separator slurry on each of the respective top and bottom coated wet electrode slurry resulting in two parallel regions of wet-on-wet areas of contact between electrode and separator to physically form two neighboring electrochemical cell portions of a solid state battery. In some embodiments, the first and second wet electrode slurry contains one or more of Silicon, Silicon, Alloy, Graphite, Lithium, and Lithium alloy. In some embodiments, the first and second wet electrode slurry contains one or more of NMC, Sulfur, Pyrite, Lithium Sulfide, and LFP. In some embodiments, the first and second separator slurry contains at least one solid electrolyte material. In some embodiments, the two-sided surface is a current collector.

Further provided herein is a product including one or more two-sided electrochemical cells made by: simultaneously coating a top side and a bottom side of a two-sided surface with first and second wet electrode slurry material, respectively; and simultaneously coating a first and second separator slurry on each of the respective top and bottom coated wet electrode slurry resulting in two parallel regions of wet-on-wet areas of contact between electrode and separator to physically form two neighboring electrochemical cell portions of a solid state battery. In some embodiments, the first and second wet electrode slurry contains one or more of Silicon, Silicon, Alloy, Graphite, Lithium, and Lithium alloy. IN some embodiments, the first and second wet electrode slurry contains one or more of NMC, Sulfur, Pyrite, Lithium Sulfide, and LFP. In some embodiments, the first and second separator slurry contains at least one solid electrolyte material. In some embodiments, the two-sided surface is a current collector.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale.

FIGS. 1A-1C show example processes of the present disclosure for making solid-state electrodes.

FIGS. 2A-2C show the binder concentration gradient in the various process steps descried herein.

FIG. 3 shows an example process of the present disclosure for making solid-state electrodes.

FIG. 4 shows an apparatus for making solid-state electrodes using the processes described herein.

FIG. 5 shows a SEM image of a solid-state electrode made using a process of the present disclosure.

FIG. 6 shows a SEM image of a solid-state electrode made using a process of the present disclosure.

FIG. 7 shows an elemental map of the electrode shown in FIG. 6.

FIG. 8 shows a chart depicting the binder concentration gradient in a composition of the present disclosure.

FIG. 9 shows an SEM image of an electrochemical cell manufactured using traditional lamination techniques after cycling.

FIG. 10 shows a chart depicting the binder concentration in the electrochemical cell shown in FIG. 9.

### DETAILED DESCRIPTION

Before the present invention is disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising, and are open ended terms.

Described herein are processes for producing solid-state multilayer electrochemical cell components. The multilayer electrochemical cell components produced by the process include a binder concentration gradient, wherein the concentration of a binder increases from a low concentration in an electrode layer to a high concentration of the binder in an electrolyte layer (also referred to herein as a separator layer). Generally, the processes comprise coating a first electrochemical cell layer slurry onto a surface; coating a second electrochemical cell layer slurry on top of the coated first electrochemical cell layer slurry while the first electrochemical cell layer slurry is still wet, such that the second electrochemical cell layer slurry and coated first electrochemical cell layer slurry are both wet and in contact; drying the first electrochemical cell layer slurry and the second electrochemical cell layer slurry to form a dried composition comprising a first electrochemical cell layer and a second electrochemical cell layer; and densifying the dried composition. The multilayer electrochemical cell components may include one or more electrode layers and/or one or more separator layers.

Also provided herein are compositions comprising an electrode layer having a first binder concentration gradient, a separator layer comprising a second binder concentration gradient, and a current collector. The electrode layer may comprise a first binder, an electrode active material (e.g., an anode active material or a cathode active material), a solid-state electrolyte material, and a conductive additive. The separator layer may comprise a solid-state electrolyte material and a second binder. The electrode layer may comprise an anode layer or a cathode layer.

The inventors found that within each individual layer of an electrochemical cell, the concentration of the binder was not constant throughout the height of the cell. Specifically, the amount of binder in the bottom of a layer (the side of the layer adjacent to the current collector or carrier foil) had a lower concentration than the opposite surface (the side furthest from the current collector or carrier foil).

Without wishing to be bound by theory, the proposed mechanism that creates this gradient effect is advection of the binder as the slurry is dried. As the coated layer dries, the bulk solvent evaporates from the surface of the layer. As the solvent is removed, a capillary effect pulls solvent from the bottom of the layer to the top. Thus, solvent concentrations at the bottom of the layer decrease quickly, causing the binder to precipitate as it reaches its solubility limit. Binder still dissolved in the solvent is pulled upward until it too reaches its solubility limit. This process repeats until the solvent is completely evaporated and all of the binder is precipitated, forming the gradient.

By creating a binder concentration gradient where the concentration of the binder at the surface interface between two layers of an electrochemical cell is the highest, a higher degree of surface-to-surface contact between the layers may be achieved without increasing the total binder concentration.

It should be understood that within the meaning of this disclosure, the phrase “first binder” may refer to a single binder or to a mixture of binders. That is, the label “first” or “second” should not be construed to limit the referenced binder to a single species. Moreover, phrases such as “the binder” or “a binder” should be construed to also refer to the first binder and/or the second binder.

### I. Wet-Coating Process

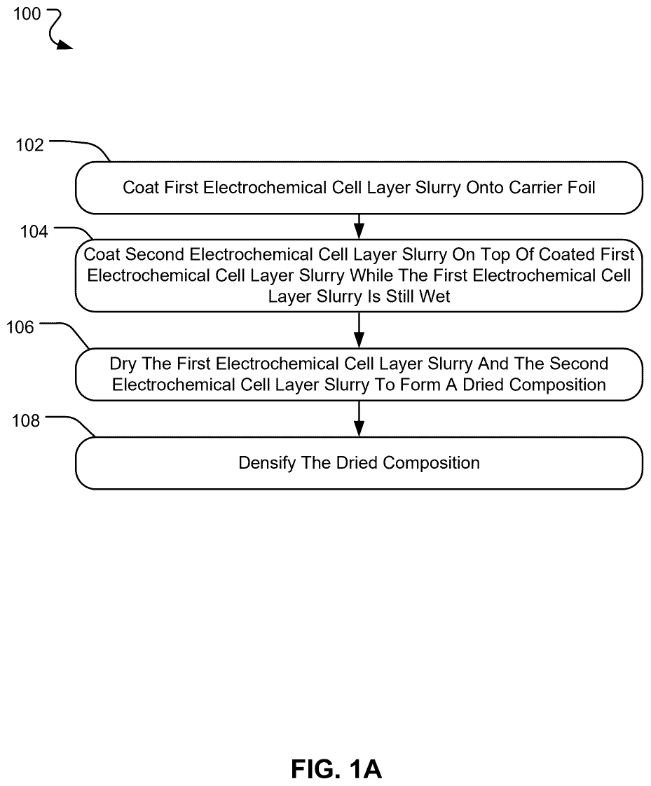

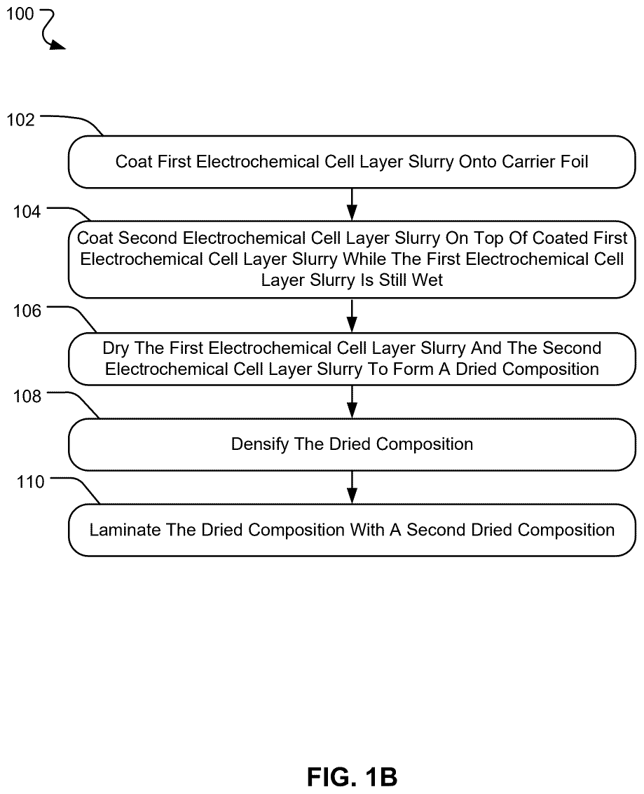

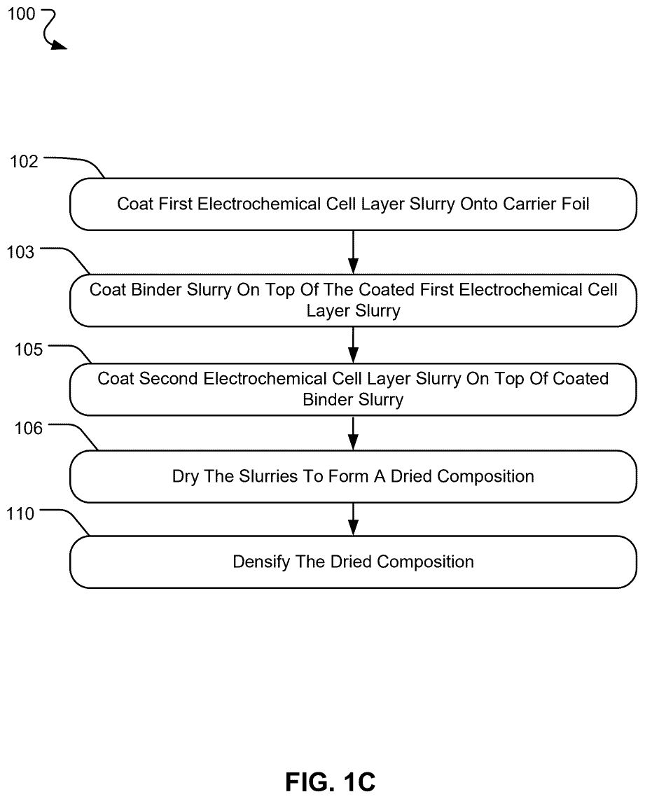

A process of the present disclosure is shown in FIG. 1A. The process 100 begins at step 102 by coating the first electrochemical cell layer slurry onto a surface. The first electrochemical cell layer slurry may be an electrode slurry (e.g., an anode slurry or a cathode slurry), a separator slurry, a binder slurry, or another slurry to make another electrochemical cell layer. The surface may comprise a carrier foil, a current collector, a dried electrochemical cell layer, or another surface. The coating may be accomplished by pouring the first electrochemical cell layer slurry onto a surface via gravity or by pumping the first electrochemical cell layer slurry onto the surface. The process may take place in ambient conditions, or may take place in an inert atmosphere such as nitrogen or argon. In some embodiments, the process may be conducted in an atmosphere comprising air and moisture. In other embodiments, the process may be conducted in an atmosphere comprising air and substantially no moisture (i.e., less than 1% humidity).

The first electrochemical cell layer slurry may be coated onto the surface at ambient temperature and pressure. In some aspects, the first electrochemical cell layer slurry may be coated onto the surface at a temperature up to the boiling point of the solvent system used in the slurry, or the slurry may be coated at cooler temperatures to limit vaporization of the solvent.

The first electrochemical cell layer slurry may include an electrode slurry. The electrode slurry may comprise an electrode active material (such as an anode active material or a cathode active material), a conductive additive, a solid-state electrolyte material, a first binder, and a solvent.

When the electrode active material is an anode active material, the anode active material may comprise one or more materials such as Silicon (Si); silicon alloy, Tin (Sn); Germanium (Ge); Carbon in the form of Graphite, Graphene, or Hard Carbon or similar; Lithium (Li); lithium alloy, Li₄Ti₅O₁₂ (LTO); or other known anode active materials or combinations thereof. Preferably, the anode active material includes silicon, lithium, or a combination thereof.

When the electrode active material is a cathode active material, the cathode active material may comprise (“NMC”) nickel-manganese-cobalt which may be expressed as Li(NiₐCo_{b}Mn_{c})O₂(0<a<1, 0<b<1, 0<c<1, a+b+c=1) or, for example, NMC 111 (LiNi_{0.33}Mn_{0.33}CO_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂(0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), lithium sulfide (Li₂s), and nickel sulfide (Ni₃S₂) or combination thereof. In still further embodiments, the cathode active material may comprise elemental sulfur (S). In additional embodiments, the cathode active material may comprise one or more of a fluoride, such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof. In some embodiments, the cathode active material may comprise lithium iron phosphate (LFP). In some embodiments, the cathode active material may comprise pyrite. Preferably, the cathode active material includes NMC, Li₂S, FeS₂, S, pyrite, LFP or a combination thereof.

The electrode active material may be present in the electrode slurry in an amount from about 30% to about 98% by weight. In some aspects, the electrode active material may be present in the electrode slurry in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight.

The electrode slurry may further optionally comprise one or more solid-state electrolyte materials. The solid-state electrolyte material, along with the conductive additive, helps to evenly distribute the charge density throughout the electrode. The one or more solid-state electrolyte material may comprise an oxide, oxysulfide, sulfide, halide, nitride, or any other solid-state electrolyte known in the art. In some preferred embodiments, the solid-state electrolyte material may comprise a sulfide solid-state electrolyte material, i.e., a solid-state electrolyte having at least one sulfur component. In some embodiments, the one or more solid-state electrolytes may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In).

In another embodiment, the solid-state electrolyte material may comprise one or more of Li₃PS₄, Li₄P₂S₆, Li₇P₃S₁₁, Li₁₀GeP₂S₁₂, Li₁₀SnP₂S₁₂. In a further embodiment, the solid-state electrolyte may comprise an argyrodite electrolyte, such as one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may include one or more of F, Cl, Br, I, and the pseudo-halogen may include one or more of N, NH, NH₂, NO, NO₂, BF₄, BH₄, AlH₄, CN, and SCN. In yet another embodiment, the solid-state electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may include one or more of F, Cl, Br, I, and the pseudo-halogen may include one or more of N, NH, NH₂, NO, NO₂, BF₄, BH₄, AlH₄, CN, and SCN. In additional embodiments, the solid-state electrolyte material may comprise a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

The solid-state electrolyte material may be present in the electrode slurry in an amount from about 0% to about 60% by weight; for example, the solid-state electrolyte may be present in the electrode slurry in an amount from about 0% to about 10% by weight, about 0% to about 20% by weight, about 0% to about 30% by weight, about 0% to about 40% by weight, about 0% to about 50% by weight, about 10% to about 60% by weight, about 20% to about 60% by weight, about 30% to about 60% by weight, about 40% to about 60% by weight, or about 50% to about 60% by weight. In some aspects, the solid-state electrolyte material may be present in the electrode slurry in an amount of about 5%, 10%, 15%, 20%, 25%, 30%, 35%, 40%, 45%, 50%, 55%, or 60% by weight of the anode layer. In an example embodiment, the solid-state electrolyte material is present in an amount from about 35% to about 45% by weight.

The electrode slurry may comprise a conductive additive. The conductive additive helps to evenly distribute the charge density throughout the anode. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, vapor grown carbon fiber (VGCF), activated carbon, and carbon nanotubes.

In some embodiments, the conductive additive may be present in the electrode slurry in an amount from about 0% to about 15% by weight. In some aspects, the conductive additive may be present in the electrode slurry in an amount from about 0% to about 10%, or about 0% to about 5% by weight. In some additional aspects, the conductive additive may be present in the anode layer in an amount of about 0%, 1%, 2%, 3%, 4%, 5%, 6%, 7%, 8%, 9%, 10%, 11%, 12%, 13%, 14%, or about 15% by weight. In an example embodiment, the conductive additive is present in the electrode slurry in an amount from about 0% to about 5% by weight.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm.

The solvent in the electrode slurry may be selected from but is not limited to one of the following: aprotic hydrocarbons, esters, ethers or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof.

The electrode slurry may have a viscosity from about 20 cP to about 3000 cP measured at a shear rate of about 100 s⁻¹. For example, the electrode slurry may have a viscosity form about 20 cP to about 100 cP, about 20 cP to about 500 cP, about 20 cP to about 1000 cP, about 20 cP to about 1500 cP, about 20 cP to about 2000 cP, about 20 cP to about 2500 cP, about 20 cP to bout 3000 cP, about 100 cP to about 3000 cP, about 500 cP to about 3000 cP, about 1000 cP to about 3000 cP, about 1500 cP to about 3000 cP, about 2000 cP to about 3000 cP, or about 2500 cP to about 3000 cP. In some embodiments, the electrode slurry may have a viscosity of about 20 cP, 50 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, 950 cP, 1000 cP, 1100 cP, 1200 cP, 1300 cP, 1400 cP, 1500 cP, 1600 cP, 1700 cP, 1800 cP, 1900 cP, 2000 cP, 2100 cP, 2200 cP, 2300 cP, 2400 cP, 2500 cP, 2600 cP, 2700 CP, 2800 cP, 2900 cP, or about 3000 cP measured at a shear rate of about 100 s⁻¹.

The first electrochemical cell layer slurry may be a separator slurry. The separator slurry (also referred to herein as the “electrolyte slurry”) may include one or more solid-state electrolytes. The one or more solid-state electrolytes may comprise an oxide, oxysulfide, sulfide, halide, nitride, or any other solid-state electrolyte known in the art. In some preferred embodiments, the one or more solid-state electrolytes may comprise a sulfide solid-state electrolyte. In some aspects, the one or more sulfide solid-state electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂. In another embodiment, one or more of the solid electrolyte materials may be an argyrodite electrolyte such as Li₆PS₅Cl, Li₆PS₅Br, Li₆PS₅I or expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, and the pseudo-halogen may be one or more of N, NH, NH₂, NO, NO₂, BF₄, BH₄, AlH₄, CN, and SCN. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN. In additional embodiments, the solid-state electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

The separator slurry may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth)acrylate, polyethyl(meth) acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

The binder may be present in the separator slurry in an amount from about 0% to about 40% by weight. For example, the binder may be present in the electrolyte layer in an amount from about 0% to about 5%, about 0% to about 10%, about 0% to about 15%, about 0% to about 20%, about 0% to about 25%, about 0% to about 30%, about 0% to about 35%, about 0% to about 40%, about 5% to about 40%, about 10% to about 40%, about 15% to about 40%, about 20% to about 40%, about 25% to about 40%, about 30% to about 40%, about 35% to about 40%, about 5% to about 15%, about 5% to about 20%, about 10% to about 15%, about 10% to about 20%, or about 15% to about 20% by weight.

In some embodiments, the separator slurry may be free of a binder before it is coated.

The solvent in the separator slurry may be selected from but is not limited to one of the following: aprotic hydrocarbons, esters, ethers or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof. The solvent may the same solvent as that used in the electrode slurry, or it may be a different solvent.

The separator slurry may have a viscosity from about 20 cP to about 3000 cP measured at a shear rate of about 100 s⁻¹. For example, the separator slurry may have a viscosity form about 20 cP to about 100 cP, about 20 cP to about 500 cP, about 20 cP to about 1000 cP, about 20 cP to about 1500 cP, about 20 cP to about 2000 cP, about 20 cP to about 2500 cP, about 20 cP to bout 3000 cP, about 100 cP to about 3000 cP, about 500 cP to about 3000 cP, about 1000 cP to about 3000 cP, about 1500 cP to about 3000 cP, about 2000 cP to about 3000 cP, or about 2500 cP to about 3000 cP. In some embodiments, the separator slurry may have a viscosity of about 20 cP, 50 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, 950 cP, 1000 cP, 1100 cP, 1200 cP, 1300 cP, 1400 cP, 1500 cP, 1600 cP, 1700 cP, 1800 cP, 1900 cP, 2000 cP, 2100 cP, 2200 cP, 2300 cP, 2400 cP, 2500 cP, 2600 cP, 2700 CP, 2800 cP, 2900 cP, or about 3000 cP measured at a shear rate of about 100 s⁻¹.

The process 100 continues at step 104 by coating a second electrochemical cell layer slurry on top of the coated first electrochemical cell layer slurry while the first electrochemical cell layer slurry is still wet; i.e., before the first electrochemical cell layer slurry has dried. This forms a wet multilayer stack. The second electrochemical cell layer slurry may be an electrode slurry, a separator slurry, or another slurry to make another layer of an electrochemical cell. The area where the coated first electrochemical cell layer slurry and the first electrochemical cell layer slurry are in physical contact with one another is referred to herein as the interface. Because the first electrochemical cell layer slurry is still wet, the binder contained in the first electrochemical cell layer slurry may move from the first electrochemical cell layer slurry into the second electrochemical cell layer slurry. This movement defines a binder concentration gradient through the first electrochemical cell layer slurry and through the second electrochemical cell layer slurry. Without wishing to be bound by theory, the binder concentration gradient may continue to advance from the first electrochemical cell layer slurry to the second electrochemical cell layer slurry until the slurries are dried.

The time between coating the first electrochemical cell layer slurry and the second electrochemical cell layer slurry is preferably minimized to ensure that the first electrochemical cell layer slurry is wet when the second electrochemical cell layer slurry is coated. For example, the second electrochemical cell layer slurry may be coated within five seconds, ten seconds, twenty seconds, thirty seconds, forty seconds, fifty seconds, one minute, two minutes, three minutes, four minutes, or within five minutes of coating the first electrochemical cell layer. In some embodiments, the second electrochemical cell layer slurry is coated on top of the coated first electrochemical cell layer slurry immediately after the first electrochemical cell layer slurry is coated.

The process 100 continues at step 106 by drying the first electrochemical cell layer slurry and the second electrochemical cell layer slurry to form a dried composition including a first electrochemical cell layer and a second electrochemical cell layer. This dried composition is also referred to herein as a dried multilayer stack. Although process 100 only depicts the formation of an electrochemical cell with two electrochemical cell layers, it is possible to form an electrochemical cell by coating more than two electrochemical cell layer slurries before drying to form an electrochemical cell with more than two layers. For instance, the processes described herein may be used to form an electrochemical cell with three layers, four layers, five, layers, six layers, and so on.

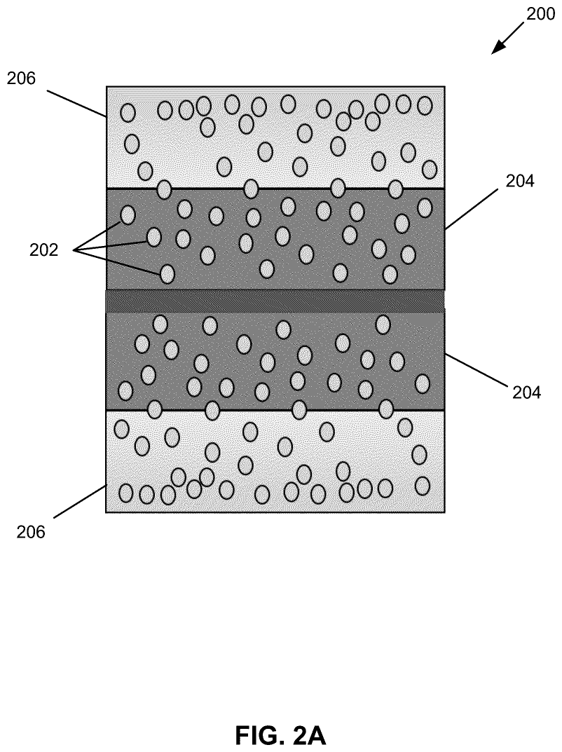

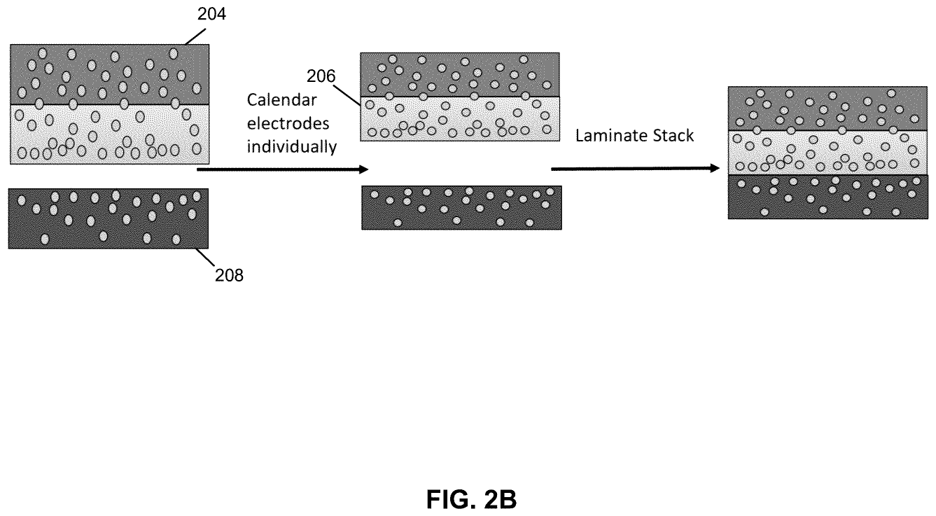

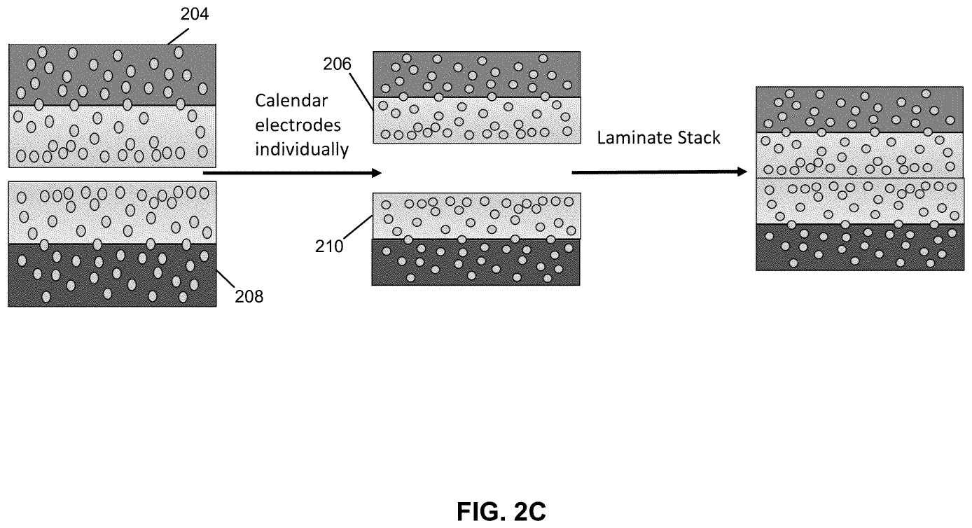

Once the slurries have dried, the movement of the binder through the layers may be limited and the binder concentration gradient is formed. As shown in FIG. 2A, binder particles 202 in the dried composition 200 have a concentration gradient through the first electrochemical cell layer 204 and the second electrochemical cell layer 206, wherein the binder particles 202 collect in the second electrochemical cell layer 206 at an end furthest from the first electrochemical cell layer 204.

Due to the movement of the binder from the first electrochemical cell layer slurry into the second electrochemical cell layer slurry, the second electrochemical cell layer 206 may include at least about 1 wt % of the binder originally included in the first electrochemical cell layer slurry. Stated another way, at least about 1 wt % of the binder originally included in the first electrochemical cell layer slurry may be included in the second electrochemical cell layer 206.

Turning back to FIG. 1A, the drying at step 106 may occur at a temperature from about 15° C. to about 300° C. For example, the drying step 106 may occur at a temperature from about 15° C. to about 30° C., about 15° C. to about 50° C., about 15° C. to about 100° C., about 15° C. to about 150° C., about 15° C. to about 200° C., about 15° C. to about 250° C., about 15° C. to about 300° C., about 30° C. to about 300° C., about 50° C. to about 300° C., about 100° C. to about 300° C., about 150° C. to about 300° C., about 200° C. to about 300° C., or about 250° C. to about 300° C. In some embodiments, the drying step 106 may occur at a temperature of about 15° C., 20° C., 25° C., 30° C., 35° C., 40° C., 45° C., 50° C., 60° C., 70° C., 80° C., 90° C., 100° C., 125° C., 150° C., 175° C., 200° C., 225° C., 250° C., 275° C., or about 300° C.

The inventors found that the temperature used during the drying step plays a role in the formation of the binder concentration gradient. For example, when the layer dried at higher temperatures, the binder concentration gradient was relatively large; e.g., the concentration of the binder at the bottom of the layer (e.g., closest to the current collector) was lower than the concentration of the binder at the top of the layer (e.g., farthest from the current collector). Other conditions, such as drying the layer under vacuum pressure or increasing air circulation during drying, also increased the binder concentration gradient. In contrast, for example, when the layer was dried at lower temperatures, the binder concentration gradient was small.

The process 100 continues at step 108 by densifying the dried composition. The composition may be densified through densification processes known to those having ordinary skill in the art, such as calendaring, linear densification, compaction, or compression. In preferred embodiments, the densifying may be accomplished via calendering.

The dried composition may have a density after densification from about 50% to about 99% of the theoretical density of the composition. The theoretical density is defined as the maximum density of the composition that could be achieved assuming there are no voids or contaminants. The density may be from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99% of the theoretical density of the dried composition.

The dried composition may have a porosity from about 1% to about 70%. For example, the dried composition may have a porosity from about 1% to about 10%, about 1% to about 20%, about 1% to about 30%, about 1% to about 40%, about 1% to about 50%, about 1% to about 60%, about 1% to about 70%, about 10% to about 70%, about 20% to about 70%, about 30% to about 70%, about 40% to about 70%, about 50% to about 70%, or about 60% to about 70%. The porosity of the dried composition may be measured through techniques known in the art, such as through SEM imaging, TEM imaging, FIB-SEM imaging, confocal microscopy, gas adsorption, mercury porosimetry, helium pycnometry, or other methods known in the art.

In another embodiment, as shown in FIG. 1B, the process 100 may further comprise step 110 of laminating the dried composition with a second dried composition. The lamination may be accomplished by lamination methods generally well known in the art, such as by calendar rolling. The lamination may further increase the density of the dried composition. The second dried composition may or may not contain a binder concentration gradient.

As shown in FIG. 2B, the second dried composition may comprise a third electrochemical cell layer 208. The third electrochemical cell layer 208 may be a separator layer, an electrode layer, or another layer electrochemical cell layer. The second dried composition may be produced using the processes described herein, or it may be produced using a different process. Generally, as shown in FIG. 2B, the second dried composition may be individually calendered separately from the first dried composition. The first dried composition and the second dried composition may be laminated together such that the second electrochemical cell layer 206 is in contact with the third electrochemical cell layer 208; however, it will be appreciated by those having ordinary skill in the art that the first dried composition and the second dried composition may be laminated together such that the first electrochemical cell layer 204 is in contact with the third electrochemical cell layer 208.

In some embodiments, as shown in FIG. 2C, the second dried composition may comprise a third electrochemical cell layer 208 and a fourth electrochemical cell layer 210. The third electrochemical cell layer 208 and the fourth electrochemical cell layer 210 may individually be a separator layer, an electrode layer, or another layer electrochemical cell layer. Generally, as shown in FIG. 2C the second dried composition may be individually calendered separately from the first dried composition.

In an example embodiment, the first electrochemical cell layer in the dried composition is an electrode layer and the second electrochemical cell layer is a separator layer. In another example embodiment, the first electrochemical cell layer in the dried composition is an electrode layer, the second electrochemical cell layer in the dried composition is a separator layer, the third electrochemical cell layer in the second dried composition is a separator layer, and the fourth electrochemical cell layer in the second dried composition is an electrode layer.

Preferably, when the first dried composition includes an anode active material in an electrode layer, the second dried composition includes a cathode active material in an electrode layer, and vice versa. Additionally, the first dried composition and the second dried composition may be laminated such that the first separator layer is in physical contact with the second electrode layer or, when present, the second separator layer. The first dried composition and the second dried composition may be laminated together such that the first separator layer 206 is in physical contact with the second separator layer 210. This arrangement creates a binder concentration gradient such that the concentration of the binder is highest at the interface between the first separator layer 206 and the second separator layer 210.

In another embodiment, as shown in FIG. 1C, the process 100 may comprise step 103 coating a binder slurry on top of the coated first electrochemical cell layer slurry, rather than coating the second electrochemical cell layer slurry on top of the coated first electrochemical cell layer slurry while the first electrochemical cell layer slurry is still wet. Without wishing to be bound by theory, the additional binder at the interface of the second electrochemical cell layer and the first electrochemical cell layer may increase the structural integrity of the two layers and/or provide better surface-to-surface contact between the two layers. The process then proceeds at step 105 by coating the second electrochemical cell layer slurry on top of the coated binder slurry before drying the slurries in step 106.

The binder slurry may comprise a binder and a solvent. In some embodiments, the binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth)acrylate, polyethyl(meth)acrylate, polyisopropyl(meth)acrylate, polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may include one or more of a nitrile rubber such as but not limited to acrylonitrile-butadiene rubber (ABR), polystyrene nitrile-butadiene rubber (PS-NBR), and mixtures thereof.

The solvent in the binder slurry may be selected from but is not limited to one of the following: aprotic hydrocarbons, esters, ethers or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof. The solvent may the same solvent as that used in the electrode slurry and/or the separator slurry, or it may be a different solvent.

The binder may be present in the binder slurry at a concentration from greater than 0% to about 99% by weight. For example, the binder may be present in the binder slurry at a concentration from greater than 0% to about 20%, greater than 0% to about 40%, greater than 0% to about 60%, greater than 0% to about 80%, greater than 0% to about 99%, about 20% to about 99%, about 40% to about 99%, about 60% to about 99%, or about 80% to about 99% by weight. In some embodiments, the binder may be present in the binder slurry at a concentration of about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or about 99%.

The binder slurry may further include a dispersant or a plasticizer. Dispersants and plasticizers suitable for use are generally known in the art.

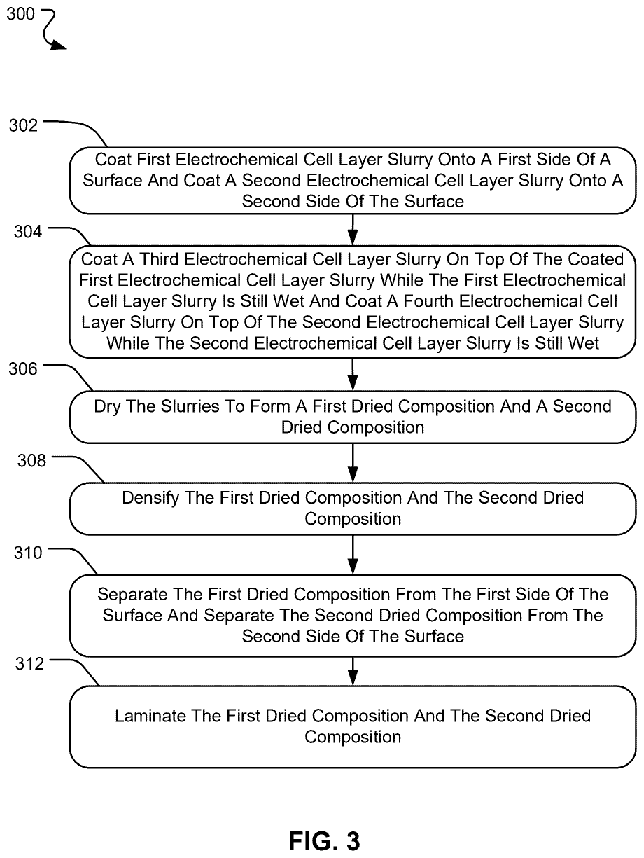

Another embodiment of the present disclosure is shown in FIG. 3. The process 300 is similar to the 100 process described in FIG. 1A. However, process 300 includes preparing both the first dried composition and the second dried composition on opposite sides of the same surface. As noted above, the surface may be a carrier foil, a current collector, a dried electrochemical cell layer, or another surface.

In step 302, a first electrochemical cell layer slurry is coated onto a first side of the surface and a second electrochemical cell layer slurry is coated onto a second side of the surface. The first electrochemical cell layer slurry and the second electrochemical cell layer slurry may comprise any of the materials or features described above with respect to the processes described in FIGS. 1A-1C. The first electrochemical cell layer slurry and the second electrochemical cell layer slurry may have the same composition or may have different compositions. In preferred embodiments, when the first electrochemical cell layer slurry comprises an anode slurry, the second electrochemical cell layer slurry comprises a cathode slurry, and vice versa.

In step 304, a third electrochemical cell layer slurry is coated on top of the coated first electrochemical cell layer slurry while the first electrochemical cell layer slurry is still wet. Simultaneously, a fourth electrochemical cell layer slurry is coated on top of the second electrochemical cell layer slurry while the second electrochemical cell layer slurry is still wet. The third electrochemical cell layer slurry and the fourth electrochemical cell layer slurry may comprise any of the materials or features described above with respect to the processes described in FIGS. 1A-1C. The third electrochemical cell layer slurry and the fourth electrochemical cell layer slurry may have the same composition or may have different compositions.

In step 306, the slurries are dried to form a first dried composition and a second dried composition. The slurries may be dried at a temperature from about 40° C. to about 300° C. For example, the slurries may be dried at a temperature from about 40° C. to about 100° C., about 40° C. to about 150° C., about 40° C. to about 200° C., about 40° C. to about 250° C., about 40° C. to about 300° C., about 100° C. to about 300° C., about 150° C. to about 300° C., about 200° C. to about 300° C., or about 250° C. to about 300° C. In some embodiments, the slurries may be dried at a temperature of about 40° C., 50° C., 60° C., 70° C., 80° C., 90° C., 100° C., 125° C., 150° C., 175° C., 200° C., 225° C., 250° C., 275° C., or about 300° C.

In step 308, the first dried composition and the second dried composition are densified. The dried compositions may be densified together or individually, as shown in FIG. 2C. The densification may be accomplished using any of the processes identified above with respect to step 108 in FIG. 1A.

In step 310, the first dried composition and the second dried composition may be separated from the surface. In some aspects, such as when the surface is a dried electrochemical cell layer, the surface may be cut to separate the surface into two sides. The first side comprises a first side of the surface and the first dried composition coated thereon. The second side comprises a second side of the surface and the second dried composition coated thereon.

In step 312, the first dried composition and the second dried composition are laminated together. Any of the processes for lamination described above with respect to step 110 in FIG. 1B may be used. The lamination may be performed such that the first separator layer 206 and the second separator layer 210 are in contact, as shown in FIG. 2C.

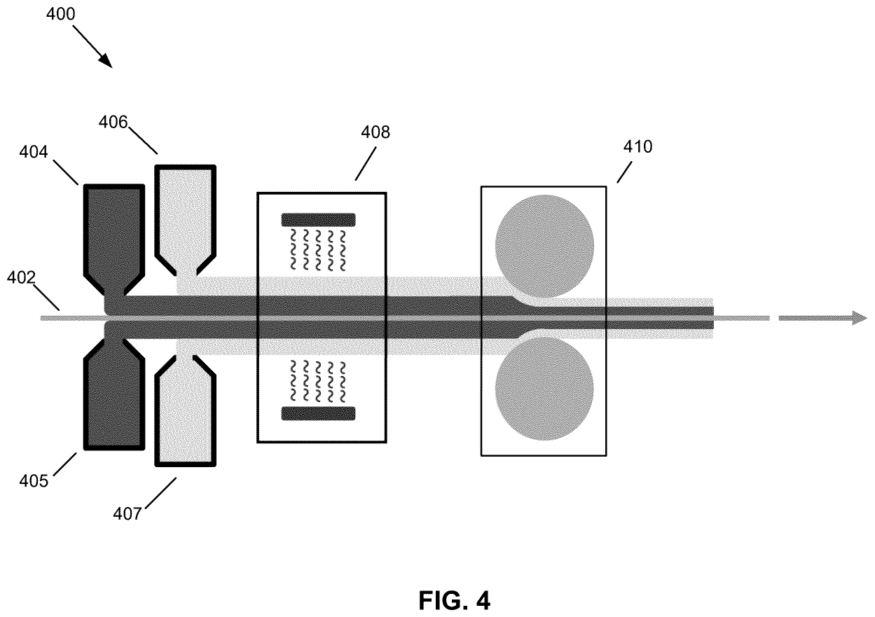

A depiction of an example process apparatus is shown in FIG. 4. Referring to FIG. 4, the apparatus 400 has two sides: Side A and Side B. The apparatus includes a surface 402, a first electrochemical cell layer slurry 404, a third electrochemical cell layer slurry 405, a second electrochemical cell layer slurry 406 a fourth electrochemical cell layer slurry 407, a drying module 408, and a densifying module 410. The two sides are oriented vertically, as shown in FIG. 1. Thus, the first electrochemical cell layer slurry 405 is deposited onto the surface 402 from below the surface 402. Likewise, the second electrochemical cell layer slurry 407 is deposited onto the surface 402 from below the surface 402. The inventors have surprisingly found that the slurries defined herein are capable of adhering to the surface 402 from below without falling or dripping from the surface 402. It will be appreciated by those having skill in the art that the process may be performed using only one of the sides; however, for efficiency and maximizing output, use of both sides is preferred.

The surface 402 may comprise a carrier foil or a current collector. The carrier foil or the current collector may comprise one or more of copper, aluminum, nickel, titanium, stainless steel, magnesium, iron, zinc, indium, germanium, silver, platinum, or gold. In some embodiments, the current collector may have a thickness from about 5 μm to about 10 μm. In some embodiments, the current collector includes a carbon coating. In preferred embodiments, the current collector comprises copper, nickel, and/or steel. Alternatively, the surface 402 may comprise a dried electrochemical cell layer.

The apparatus 400 shown in FIG. 4 may be used in a process for producing electrochemical cells as described herein. The process generally includes simultaneously coating a tope side and a bottom side of a two-sided surface with a first wet electrode slurry and a second wet electrode slurry, respectively; and, simultaneously coating a first separator slurry and a second separator slurry on each of the respective top and bottom coated wet electrode slurry resulting in two parallel regions of wet-on-wet areas of contact between electrode and separator to physically form two neighboring electrochemical cell portions of a solid state battery. The first and second wet electrode slurries may each be any of the electrode slurries described herein. The first and second separator slurries may each be any of the separator slurries described herein. The two-sided surface may be any of the surfaces provided herein.

### II. Compositions

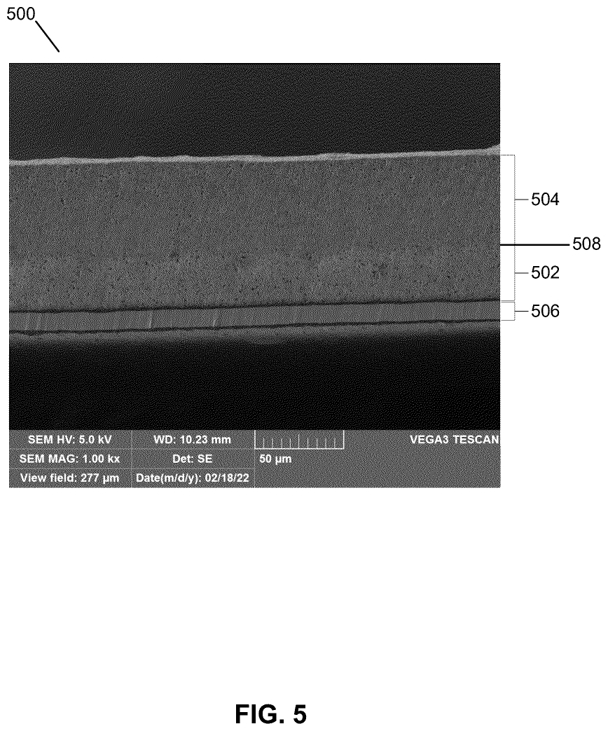

Further provided herein are compositions produced by the process described above. Referring now to the SEM of such a composition shown in FIG. 5, the composition 500 comprises an electrode layer 502, a separator layer 504, and a current collector 506. The electrode layer 502 may be an anode layer or a cathode layer. The point of contact between the electrode layer 502 and the separator layer 504 defines an interface 508 (also referred to herein as a “particle interface”). The electrode layer 502 may have a first side that is adjacent to the separator layer 504 and a second side adjacent to the current collector 506. The separator layer 504 may have a first side adjacent to the electrode layer 502 and a second side adjacent to the atmosphere or to a second electrode layer if included in an electrochemical cell (described further below).

The electrode layer 502 may comprise an electrode active material (such as an anode active material or a cathode active material), a conductive additive, a solid-state electrolyte material, and a first binder. The separator layer 504 may comprise a solid-state electrolyte material and a second binder. In some embodiments, the first binder and the second binder may be the same; i.e., the first binder may be the same species of binder as the second binder; however, even when the first binder is the same as the second binder, the first binder may have a different molecular weight, solubility, or other different physical qualities than the second binder. In some other embodiments, the first binder and the second binder may be different.

The first binder concentration gradient and the second binder concentration gradient may define a continual binder gradient across the interface 508. The continual binder gradient across the gradient comprises no discontinuity in the gradient at the interface. Stated differently, continual binder gradient across the gradient also comprises substantially similar concentration immediately on either side of the interface, while there is also a gradient across the interface. Thus, in some examples, the first binder concentration at an area of the electrode layer 502 close to the interface 508 (e.g., within 1 μm of the electrode layer) may be substantially the same (i.e., ±5%) as the second binder concentration in the separator layer 504 at an area close to the interface 508. This continual binder concentration gradient may extend from the first side of the electrode layer 502 to the second side of the separator layer 504.

In some embodiments, the concentration of the first binder in the electrode layer is ±5% or less by weight the concentration of the second binder in the separator layer at the interface. In some aspects, the concentration of the first binder in the electrode layer is ±5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, or less than 0.01% by weight the concentration of the second binder in the separator layer at the interface.

When the first binder and the second binder are the same species, the second binder may have been originally included in the electrode layer when the electrode layer was coated as an electrode layer slurry, whereby the binder in the electrode layer slurry migrated into the separator layer slurry coated on top of the electrode layer slurry while the slurries were wet, as described hereinabove. Therefore, the second binder in the separator layer 504 may be a binder that was originally included in the electrode layer slurry before the electrode layer 502 was formed. In some embodiments, at least 1 wt % of the binder originally included in the electrode layer slurry may be included in the separator layer 504 after the electrode layer 502 and the separator layer 504 are dried.

The composition may further comprise a bridging network spanning the interface 508. The bridging network is a structure that results from the binder precipitating at the interface 508 as the solvent evaporates, forming “bridges” of binder that span the interface 508 between the electrode layer 502 and the separator layer 504. Without wishing to be bound by theory, this bridging network increases the particle-to-particle contact between the electrode layer 502 and the separator layer 504.

When the electrode layer 502 is an anode layer, the anode layer may comprise one or more anode active materials. In one embodiment, the anode active material may comprise one or more materials such as Silicon (Si), silicon alloy, Tin (Sn), Germanium (Ge), graphite, Lithium (Li), lithium alloy, Li₄Ti₅O₁₂ (LTO) or other known anode active materials. In some embodiments, the anode layer may be a bilayer anode.

In some embodiments, the anode active material may be present in the anode layer in an amount of about 30% to about 98% by weight of the anode layer. In some aspects, the anode active material may be present in the anode layer in an amount from about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the anode layer.

In some embodiments, the anode layer may have a thickness of about 1 μm to about 100 μm. In some aspects, the anode layer may have a thickness from about 1 μm to about 10 μm, about 1 μm to about 20 μm, about 1 μm to about 30 μm, about 1 μm to about 40 μm, about 1 μm to about 50 μm, about 1 μm to about 60 μm, about 1 μm to about 70 μm, about 1 μm to about 80 μm, about 1 μm to about 90 μm, about 10 μm to about 100 μm, about 20 μm to about 100 μm, about 30 μm to about 100 μm, about 40 μm to about 100 μm, about 50 μm to about 100 μm, about 60 μm to about 100 μm, about 70 μm to about 100 μm, about 80 μm to about 100 μm, about 90 μm to about 100 μm, about 10 μm to about 50 μm, about 20 μm to about 40 μm, or about 20 μm to about 30 μm. In some additional aspects, the anode layer may have a thickness of about 1 μm, 5 μm, 10 μm, 20 μm, 30 μm, 40 μm, 50 μm, 60 μm, 70 μm, 80 μm, 90 μm, or about 100 μm. In an example embodiment, the anode layer has a thickness of about 20 μm to about 30 μm.

In some embodiments, the anode layer may optionally further comprise one or more conductive additives. The conductive additive helps to evenly distribute the charge density throughout the anode. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, vapor grown carbon fiber (VGCF), activated carbon, and carbon nanotubes.

In some embodiments, the conductive additive may be present in the anode layer in an amount from about 0% to about 15% by weight of the anode layer. In some aspects, the conductive additive may be present in the anode layer in an amount from about 0% to about 10%, or about 0% to about 5% by weight of the anode layer. In some additional aspects, the conductive additive may be present in the anode layer in an amount of about 0%, 1%, 2%, 3%, 4%, 5%, 6%, 7%, 8%, 9%, 10%, 11%, 12%, 13%, 14%, or about 15% by weight of the anode layer. In an example embodiment, the conductive additive is present in the anode layer in an amount from about 0% to about 5% by weight of the anode layer.

In some embodiments, the average particle size of the conductive additive may be from about 5 nm to about 100 nm. In some aspects, the average particle size of the conductive additive may be from about 5 nm to about 10 nm, about 5 nm to about 20 nm, about 5 nm to about 30 nm, about 5 nm to about 40 nm, about 5 nm to about 50 nm, about 5 nm to about 60 nm, about 5 nm to about 70 nm, about 5 nm to about 80 nm, about 5 nm to about 90 nm, about 10 nm to about 100 nm, about 20 nm to about 100 nm, about 30 nm to about 100 nm, about 40 nm to about 100 nm, about 50 nm to about 100 nm, about 60 nm to about 100 nm, about 70 nm to about 100 nm, about 80 nm to about 100 nm, about 90 nm to about 100 nm, about 10 nm to about 50 nm, or about 20 nm to about 40 nm. In some examples, the conductive additive may have a particle size of about 30 nm.

In some embodiments, the anode layer may further optionally comprise one or more solid-state electrolyte materials. The solid-state electrolyte material, along with the conductive additive, helps to evenly distribute the charge density throughout the anode. The one or more solid-state electrolyte material may comprise an oxide, oxysulfide, sulfide, halide, nitride, or any other solid-state electrolyte known in the art. In some preferred embodiments, the one or more solid-state electrolyte materials may comprise a sulfide solid-state electrolyte material, i.e., a solid-state electrolyte having at least one sulfur component. In some embodiments, the one or more solid-state electrolytes may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In).

In another embodiment, the solid-state electrolyte material may be one or more of Li₃PS₄, Li₄P₂S₆, Li₇P₃S₁₁, Li₁₀GeP₂S₁₂, Li₁₀SnP₂S₁₂. In a further embodiment, the solid-state electrolyte may be an argyrodite electrolyte, such as one or more of a Li₆PS₅Cl, Li₆PS₅Br, Li₆PS5I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid-state electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN. In additional embodiments, the solid-state electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In some aspects, the solid-state electrolyte material may be present in the anode layer in an amount from about 0% to about 60% by weight of the anode layer; for example, the solid-state electrolyte may be present in the anode layer in an amount from about 0% to about 10% by weight, about 0% to about 20% by weight, about 0% to about 30% by weight, about 0% to about 40% by weight, about 0% to about 50% by weight, about 10% to about 60% by weight, about 20% to about 60% by weight, about 30% to about 60% by weight, about 40% to about 60% by weight, or about 50% to about 60% by weight. In some aspects, the solid-state electrolyte material may be present in the anode layer in an amount of about 5%, 10%, 15%, 20%, 25%, 30%, 35%, 40%, 45%, 50%, 55%, or 60% by weight of the anode layer. In an example embodiment, the solid-state electrolyte material is present in an amount from about 35% to about 45% by weight of the anode layer.

The anode layer may further comprise a binder. The binder aids in adhesion of the anode layer to the current collector and increases the structural integrity of the anode layer. Additionally, the binder may enable improved cohesion between like particles in different layers of an electrochemical cell (e.g., an electrolyte). The binder also forms a flexible matrix when mixed with the solid-state electrolyte material. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like.

In a further embodiment, the binder may be one or more of an acrylic resin such as but not limited to polymethyl(meth) acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In preferred embodiments, the binder is a styrenic block copolymer. In an example embodiment, the binder is SEBS. In another example embodiment, the binder comprises SEBS and SBS.

In some aspects, the binder may be present in the anode layer in an amount from about 0% to about 20% by weight of the anode layer; for example, the binder may be present in the anode layer in an amount from about 0% to about 5%, about 0% to about 10%, about 0% to about 15%, about 5% to about 20%, about 10% to about 20%, or about 15% to about 20%. In an example embodiment, the binder is present in the anode layer in an amount from about 4% to about 5% by weight.

The anode layer may have a density from about 1.0 g/cm³ to about 4.0 g/cm³. In some embodiments, the first anode layer may have a density from about 1.0 g/cm³ to about 1.5 g/cm³, about 1.0 g/cm³ to about 2.0 g/cm³, about 1.0 g/cm³ to about 2.5 g/cm³, about 1.0 g/cm³ to about 3.0 g/cm³, about 1.0 g/cm³ to about 3.5 g/cm³, about 1.0 g/cm³ to about 4.0 g/cm³, about 1.5 g/cm³ to about 4.0 g/cm³, about 2.0 g/cm³ to about 4.0 g/cm³, about 2.5 g/cm³ to about 4.0 g/cm³, about 3.0 g/cm³ to about 4.0 g/cm³, about 3.5 g/cm³ to about 4.0 g/cm³, about 2.0 g/cm³ to about 3.0 g/cm³, about 2.0 g/cm³ to about 3.5 g/cm³, or about 2.5 g/cm³ to about 3.5 g/cm³.

When the electrode layer 502 is a cathode layer, the cathode layer may include a cathode active material such as (“NMC”) nickel-manganese-cobalt which may be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCO_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combination thereof. In still further embodiments, the cathode active material may comprise elemental sulfur (S). In additional embodiments, the cathode active material may comprise one or more of a fluoride, such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof. In some embodiments, the cathode active material may comprise lithium iron phosphate (LFP). In some embodiments, the cathode active material may comprise pyrite. In some embodiments, the cathode layer may comprise a bilayer cathode.

The cathode layer may further comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, vapor grown carbon fiber (VGCF), activated carbon, and carbon nanotubes. In some aspects, the conductive additive may be present in the cathode layer in an amount from about 1% to about 10%.

The cathode layer may further comprise one or more solid-state electrolytes. The one or more solid-state electrolyte may comprise an oxide, oxysulfide, sulfide, halide, nitride, or any other solid-state electrolyte known in the art. In some preferred embodiments, the one or more solid-state electrolytes may comprise a sulfide solid-state electrolyte. In some embodiments, the solid-state electrolyte comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In another embodiment, the solid-state electrolyte may be one or more of a Li₃PS₄, Li₄P₂S₆, Li₇P₃S₁₁, Li₁₀GeP₂S₁₂, Li₁₀SnP₂S₁₂. In a further embodiment, the solid-state electrolyte may be an argyrodite electrolyte, such as one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, and SCN. In yet another embodiment, the solid-state electrolyte be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In additional embodiments, the solid-state electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In some embodiments, the solid state electrolyte may be present in the cathode layer 104 in an amount from about 5% to about 50% by weight of the cathode layer. In some aspects, the solid state electrolyte may be present in the cathode layer in an amount from about 5% to about 10%, about 5% to about 15%, about 5% to about 20%, about 5% to about 25%, about 5% to about 35%, about 5% to about 40%, about 5% to about 50%, about 10% to about 50%, about 15% to about 50%, about 20% to about 50%, about 25% to about 50%, about 30% to about 50%, about 35% to about 50%, about 40% to about 50%, about 45% to about 50%, about 10% to about 30%, about 10% to about 40%, about 20% to about 30%, or about 20% to about 40% by weight of the cathode layer. In some additional aspects, the solid state electrolyte may be present in the cathode layer in an amount of about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or about 50% by weight of the cathode layer.

The cathode layer may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In some embodiments, the binder may be present in the cathode layer in an amount from about 0% to about 20% by weight of the cathode layer. In some aspects, the binder may be present in the cathode layer in an amount from about 0% to about 5%, about 0% to about 10%, about 0% to about 15%, about 0% to about 20%, about 5% to about 10%, about 5% to about 15%, about 5% to about 20%, about 10% to about 15%, about 10% to about 20%, or about 15% to about 20% by weight of the cathode layer. In some additional aspects, the conductive additive may be present in the cathode layer in an amount of about 0%, 1%, 2%, 3%, 4%, 5%, 6%, 7%, 8%, 9%, 10%, 11%, 12%, 13%, 14%, 15%, 16%, 17%, 18%, 19%, or about 20% by weight of the cathode layer.

The cathode layer may have a density from about 1.0 g/cm³ to about 4.0 g/cm³. In some embodiments, the first anode layer may have a density from about 1.0 g/cm³ to about 1.5 g/cm³, about 1.0 g/cm³ to about 2.0 g/cm³, about 1.0 g/cm³ to about 2.5 g/cm³, about 1.0 g/cm³ to about 3.0 g/cm³, about 1.0 g/cm³ to about 3.5 g/cm³, about 1.0 g/cm³ to about 4.0 g/cm³, about 1.5 g/cm³ to about 4.0 g/cm³, about 2.0 g/cm³ to about 4.0 g/cm³, about 2.5 g/cm³ to about 4.0 g/cm³, about 3.0 g/cm³ to about 4.0 g/cm³, about 3.5 g/cm³ to about 4.0 g/cm³, about 2.0 g/cm³ to about 3.0 g/cm³, about 2.0 g/cm³ to about 3.5 g/cm³, or about 2.5 g/cm³ to about 3.5 g/cm³.

The separator layer 504 (also referred to herein as the “electrolyte layer”) may include one or more solid-state electrolytes. The one or more solid-state electrolytes may comprise an oxide, oxysulfide, sulfide, halide, nitride, or any other solid-state electrolyte known in the art. In some preferred embodiments, the one or more solid-state electrolytes may comprise a sulfide solid-state electrolyte. In some aspects, the one or more sulfide solid-state electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂. In another embodiment, one or more of the solid electrolyte materials may be an argyrodite electrolyte such as Li₆PS₅Cl, Li₆PS₅Br, Li₆PS₅I or expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, and the pseudo-halogen may be one or more of N, NH, NH₂, NO, NO₂, BF₄, BH₄, AlH₄, CN, and SCN. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN. In additional embodiments, the solid-state electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

The separator layer 504 may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth) acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

The binder may be present in the electrolyte layer in an amount of about 0% to about 40% by weight. For example, the binder may be present in the electrolyte layer in an amount of about 0% to about 5%, about 0% to about 10%, about 0% to about 15%, about 0% to about 20%, about 0% to about 25%, about 0% to about 30%, about 0% to about 35%, about 0% to about 40%, about 5% to about 40%, about 10% to about 40%, about 15% to about 40%, about 20% to about 40%, about 25% to about 40%, about 30% to about 40%, about 35% to about 40%, about 5% to about 15%, about 5% to about 20%, about 10% to about 15%, about 10% to about 20%, or about 15% to about 20% by weight.

Generally, it is desired to minimize the conductivity of the electrolyte layer. Therefore, in some embodiments, the electrolyte layer comprises no conductive additive, or only trace amounts of a conductive additive.

The electrolyte layer may have a density from about 1.0 g/cm³ to about 2.0 g/cm³. In some embodiments, the first anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

In some embodiments, the separator layer 504 may have a thickness from about 10-75 μm. In some aspects, the electrolyte layer may have a thickness from about 10 μm to about 20 μm, about 10 μm to about 30 μm, about 10 μm to about 40 μm, about 10 μm to about 50 μm, about 10 μm to about 60 μm, about 10 μm to about 70 μm, about 10 μm to about 75 μm, about 20 μm to about 75 μm, about 30 μm to about 75 μm, about 40 μm to about 75 μm, about 50 μm to about 75 μm, about 60 μm to about 75 μm, about 70 μm to about 75 μm, about 20 μm to about 40 μm, about 20 μm to about 60 μm, about 30 μm to about 60 μm, or about 40 μm to about 60 μm. In some additional aspects, the electrolyte layer may have a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, or about 75 μm.

The current collector 506 may comprise one or more of copper, aluminum, nickel, titanium, stainless steel, magnesium, iron, zinc, indium, germanium, silver, platinum, or gold. In some embodiments, the current collector 506 may have a thickness of about 5 μm to about 10 μm. In some embodiments, the current collector includes a carbon coating. In preferred embodiments, the current collector 506 comprises copper, nickel, and/or steel.

Further provided herein is a composition comprising an electrode slurry in contact with a surface and a separator slurry in contact with the electrode slurry, wherein the separator slurry and the coated electrode slurry are in contact while wet. As used herein, the slurries are considered “wet” until substantially all of the solvent has been removed from the slurry (e.g., 95% by weight or more). Once substantially all of the solvent has been removed from the slurry, the slurry and/or individual components of the slurry may not exhibit movement, settling, redistribution, or advection. The electrode slurry and the separator slurry may comprise any of the materials or features described above.

A wet slurry as defined herein may have a solvent content of about 5 wt % or more. For example, a wet slurry may have a solvent content of about 5 wt % or more, about 10 wt % or more, about 20 wt % or more, about 30 wt % or more, about 40 wt % or more, about 50 wt % or more, about 60 wt % or more, about 70 wt % or more, about 80 wt % or more, or about 90 wt % or more.

### III. Electrochemical Cell

Further provided herein is an electrochemical cell. The electrochemical cell comprises a current collector, an electrode layer having a first side in operable contact with the current collector and a second side opposite to the first side, and a separator layer having a first side in direct contact with the second side of the electrode layer and a second side opposite to the first side, the separator layer comprising a second binder. The electrode layers and the separator layer may be any of those described above in Section II. The first electrode layer and the second electrode layer may each be one of an anode layer or a cathode layer, with the caveat that if the first electrode layer is an anode layer, then the second electrode layer is a cathode layer, and vice versa. The first binder in the electrode layer and the second binder in the separator layer may be the same. The concentration of the first binder in the electrode layer and the concentration of the second binder in the separator layer defines a gradient having a maximum concentration at the second side of the separator layer and a minimum concentration at a point in the electrode layer. Additionally, the concentration of the first binder at the first side of the separator layer is substantially the same as the concentration of the second binder at the second side of the electrode layer.

In another embodiment, the electrochemical cell comprises a first current collector, a first electrode layer having a first side in operable contact with the current collector and a second side opposite to the first side, and a separator layer having a first side in direct contact with the second side of the first electrode layer and a second side opposite to the first side, the separator layer comprising a second binder. The first electrode layer and the second electrode layer may each be one of an anode layer or a cathode layer, with the caveat that if the first electrode layer is an anode layer, then the second electrode layer is a cathode layer, and vice versa. The anode layer may comprise a bilayer anode. The cathode layer may comprise a bilayer cathode. The first binder in the first electrode layer and the second binder in the separator layer may be the same species of binder. The concentration of the first binder in the first electrode layer and the concentration of the second binder in the separator layer defines a gradient having a maximum concentration at the second side of the separator layer and a minimum concentration at a point in the first electrode layer. In some examples, the minimum concentration occurs at the interface between the first current collector and the first side of the first electrode layer. Additionally, the concentration of the first binder at the first side of the separator layer is substantially the same as the concentration of the second binder at the second side of the first electrode layer.

The electrochemical cell may further comprise a second electrode layer, the second electrode layer having a first side in direct contact with the separator layer and a second side. The second side of the second electrode layer may be in operable contact with a second current collector. The second electrode layer may comprise a third binder, which may be the same as or different from the first binder and/or the second binder. The second electrode layer may or may not comprise a third binder concentration gradient similar to that of the first electrode layer. When the second electrode layer does comprise a binder concentration gradient, the minimum concentration of the third binder is on the second side of the electrode layer and a maximum concentration at the first side of the separator layer.

In another embodiment, the electrochemical cell comprises a first current collector; a first electrode layer having a first side in operable contact with the current collector and a second side opposite to the first side, the first electrode layer comprising a first binder; a first separator layer having a first side in direct contact with the second side of the first electrode layer and a second side opposite to the first side, the first separator layer comprising a second binder; a second separator layer having a first side and a second side in contact with the second side of the first separator layer, the second separator layer comprising a third binder; a second electrode layer having a first side and a second side in direct contact with the first side of the second separator layer, the second electrode layer comprising a fourth binder; and a current collector in operable contact with the first side of the second electrode layer. The first electrode layer and the second electrode layer may each be one of an anode layer or a cathode layer, with the caveat that if the first electrode layer is an anode layer, then the second electrode layer is a cathode layer, and vice versa. The first binder in the first electrode layer, the second binder in the first separator layer, the third binder in the second separator layer, and the fourth binder in the second electrode layer may each be a different species of binder, or two or more may be the same species of binder. The first, second, third, and fourth binders may define a binder concentration gradient that has maximum concentrations at the first side of the first electrode layer and at the second side of the second electrode layer and has a minimum concentration at the interface between the second side of the first separator layer and the second side of the second separator layer.

### IV. Methods

Further provided herein is a method of increasing adhesion between a solid-state electrode and a separator layer. The method includes contacting a surface of an electrode layer comprising a first set of one or more particles with a surface of a separator layer comprising a second set of one or more particles to create a particle interface and migrating the first set or second set across the particle interface to produce a particle gradient. The migration of the first set or the second set of particles across the particle interface may be accomplished by advection of one or more solvents. The particle gradient may be visible under SEM. SEM images of the particle gradient may be visible as physical connections formed across the particle interface. The physical connections may be formed between binder particles in the first set of one or more particles or in the second set of one or more particles. The binder particles may comprise any binder described herein.

The first set of one or more particles may include an electrode active material, a binder, a solid-state electrolyte material, and/or a conductive additive of the present disclosure. The second set of one or more particles may include a binder, a solid-state electrolyte material, and/or a conductive additive of the present disclosure.

In some embodiments, the method may further include pressing the electrode layer and the separator layer together. The pressing may be accomplished using methods known in the art, such as laminating, calendaring or machine pressing.

The pressing may be accomplished at a pressure from about 100 psi to about 500,000 psi. For example, the pressing may be accomplished from about 100 psi to about 500 psi, about 500 psi to about 1,000 psi, about 1,000 psi, about 1,000 psi to about 5,000 psi, about 5,000 psi to about 10,000 psi, about 10,000 psi to about 50,000 psi, about 50,000 psi to about 100,000 psi, about 100 psi to about 1,000 psi, about 100 psi to about 5,000 psi, about 100 psi to about 10,000 psi, about 100 psi to about 50,000 psi, about 100 psi to about 100,000 psi, about 500 psi to about 100,000 psi, about 1,000 psi to about 100,000 psi, about 5,000 psi to about 100,000 psi, about 10,000 psi to about 100,000 psi, or about 50,000 psi to about 100,000 psi.

Further provided herein is a method of producing layers for use in a solid-state electrochemical cell. The method includes depositing two or more layers in close proximity to one another, each layer comprising one or more solvent; increasing the surface-to-surface contact of at least one layer to a second layer to produce a surface interface, and substantially removing the one or more solvent. Each layer may be an electrode layer or a separator layer as described herein. As used herein, the phrase “close proximity” may be used to indicate that the two or more layers are deposited such that the two or more layers are making contact with one another or it may be used to indicate that the two or more layers are deposited such that the two or more layers are separated by a small distance (i.e., less than 1 cm). When deposited, the layers may be in the form of a slurry. The one or more solvent may be any of the solvents described herein. The one or more solvent may comprise a dissolved binder, the dissolved binder being any of the binders described herein.

Increasing the surface-to-surface contact of the at least one layer to the second layer to produce a surface interface may be accomplished by pressing the at least one layer and the second layer using any method of pressing known in the art.

Substantially removing the one or more solvent may be accomplished by methods known in the art, including by drying or by adjusting ambient temperature or pressure to induce or accelerate evaporation of the one or more solvent. As used herein “substantially removing the one or more solvent” means that the final composition comprises essentially no solvent (i.e., less than 1% by weight of the one or more solvents). In preferred embodiments, the final composition comprises less than 0.1% by weight of the one or more solvents. In more preferred embodiments, the final composition comprises no solvent.

Further provided herein is a method of producing layers for use in a solid-state electrochemical cell. The method comprises producing a first layer and a second layer in slurry form, each layer comprising one or more solvents; coating the first layer onto a carrier foil or a current collector; coating the second layer onto the carrier foil or current collector in close proximity to the first layer; increasing a surface-to-surface contact of the first layer and the second layer; and substantially removing the one or more solvents. Coating may be accomplished by tape casting. Systems and methods for tape casting are generally known in the art. Each of the layers may be an electrode layer or a separator layer as described herein. In some embodiments, the first layer is an electrode layer and the second layer is a separator layer.

When the first layer is an anode layer, the carrier foil may comprise copper, nickel, stainless steel, lithium alloys, or carbon fiber. In some aspects, the carrier foil may be coated with carbon.

When the first layer is a cathode layer, the carrier foil may comprise aluminum, copper, or stainless steel.

The one or more solvents may be any of the solvents described herein. The one or more solvents may comprise a dissolved binder, which may be any binder described herein.

Substantially removing the one or more solvent may be accomplished by methods known in the art, including by drying or by adjusting ambient temperature or pressure to induce or accelerate evaporation of the one or more solvent. The method may further comprise generating a capillary effect through the first and second electrode layer. The capillary effect may be generated by evaporation of the one or more solvents. In order to generate the capillary effect, the binders must be soluble in the solvent that is used. If the binder is not dissolved, it will be unable to move within the layers. Additionally, the layers must have sufficient porosity to allow the binder to travel during the drying process.

In embodiments where the layers are dried, the dried electrode layers may be incorporated into an electrochemical cell or battery. In some embodiments, the battery may comprise layers, wherein each layer has at least one solid-to-solid interface with another layer of the battery. For example, a battery may include a solid anode layer, a solid separator layer, and a solid cathode layer, each layer having a solid-to-solid interface between each layer.

The surface-to-surface contact of the first and second layer may be increased by pressing methods described herein and known in the art.

### Enumerated Embodiments

Embodiment 1: A process for making electrochemical cells involving coating a first wet slurry on a surface forming a first coated layer, coating a second wet slurry on top of the first coated layer forming a wet multilayer stack, resulting in an initial wet-on-wet contact between the first coated layer and the second coated layer forming an interface to define a portion of an electrochemical cell.

Embodiment 2: The process of embodiment 1, wherein one or more of the first wet slurry and the second wet slurry contains a solid electrolyte material.

Embodiment 3: The process of embodiment 1 or 2, wherein one or more of the first coated layer and the second coated layer comprises a binder material.

Embodiment 4: The process of any one of embodiments 1-3, wherein the first wet slurry and the second wet slurry are coated simultaneously.

Embodiment 5: The process of any one of embodiments 1-4, wherein the surface is a carrier foil or a current collector.

Embodiment 6: The process of any one of embodiments 1-5, wherein the surface is one of Aluminum, Copper, Lithium, or Magnesium.

Embodiment 7: The process of embodiment 3, comprising drying the wet multilayer stack forming a dried multilayer stack.

Embodiment 8: The process of embodiment 7, wherein, the dried multilayer stack comprises an electrode layer or separator layer.

Embodiment 9: The process of embodiment 7 or 8, wherein at least 1% of the binder in the first coated layer migrates across the interface into the second coated layer during drying.

Embodiment 10: The process of any one of embodiments 7-9, further comprising laminating the dried multilayer stack with a dried coated layer to form a complete electrochemical cell.

Embodiment 11: The process of embodiment 10, wherein the dried coated layer comprises an electrode.

Embodiment 12: The process of embodiment 10, wherein the dried coated layer is a second multilayer stack and is made by coating a wet electrode slurry on a surface to form a first coated electrode layer, and coating a wet separator slurry on top of the coated electrode layer to forming a wet multilayer stack, where the wet multilayer stack is then dried.

Embodiment 13: A process comprising:
coating a binder slurry onto a carrier foil, the binder slurry including a binder;
coating an electrode slurry on top of the coated binder slurry while the binder slurry is still wet, such that the binder slurry and coated electrode slurry are both wet and in contact;
coating a separator slurry on top of the coated electrode slurry while the electrode slurry is still wet;
drying the binder slurry, the electrode slurry, and the separator slurry to form a dried composition comprised of a first electrode layer and a first separator layer; and
densifying the dried composition.

Embodiment 14: An electrochemical cell produced by:
coating an electrode slurry onto a surface;
coating a separator slurry on top of the coated electrode slurry while the electrode slurry is still wet, such that the separator slurry and coated electrode slurry are both wet and in contact;
drying the electrode slurry and the separator slurry to form a dried composition comprised of a first electrode layer and a first separator layer;
densifying the dried composition; and
laminating the dried composite with a dried coated layer to form a completed electrochemical cell.

Embodiment 15: The electrochemical cell of embodiment 14, wherein the first electrode layer comprises one or more of a silicon containing material and at least one binder.

Embodiment 16: The electrochemical cell of embodiment 14 or 15, wherein the first electrode layer comprises a cathode active material and at least one binder.

Embodiment 17: The electrochemical cell of any one of embodiments 14-16, wherein the separator layer comprises a solid electrolyte material.

Embodiment 18: The electrochemical cell of any one of embodiments 14-17, wherein the dried coated layer contains one or more of a Silicon, Silicon Alloy, Graphite, Lithium, or Lithium alloy.

Embodiment 19: The electrochemical cell of any one of embodiments 14-18, wherein the dried coated layer contains one or more of NMC, Sulfur, Pyrite, Lithium Sulfide, or LFP.

Embodiment 20: The electrochemical cell of any one of embodiments 14-19, wherein the dried coated layer is a second dried composition comprising a second electrode layer and a second separator layer.

Embodiment 21: A composition including an electrode layer with a first binder concentration gradient, and a separator layer formed on top of the electrode layer to form an interface and having a second binder concentration gradient, the first and second binder concentration gradients defining a continual binder concentration gradient across the interface.

Embodiment 22: The composition of embodiment 21, wherein the separator layer is adjacent to the electrode layer, and wherein the continual binder concentration gradient extends from a side of the electrode layer at the current collector through the separator layer.

Embodiment 23: The composition of embodiment 21 or 22, wherein the composition comprises a bridging network spanning the interface.

Embodiment 24: The composition of embodiment 3, wherein the concentration of the first binder in the electrode layer at the interface is ±5% or less by weight the concentration of the second binder in the separator layer at the interface.

Embodiment 25: The composition of any one of embodiments 21-24, wherein the electrode layer comprises one or more anode layers.

Embodiment 26: The composition of embodiment 25, wherein the one or more anode layers include one or more of Silicon, Silicon Alloy, Graphite, Lithium, and Lithium alloy.

Embodiment 27: The composition of any one of embodiments 21-26, wherein the electrode layer comprises one or more cathode layers.

Embodiment 28: The composition of embodiment 27, wherein the one or more cathode layers include one or more of NMC, Sulfur, Pyrite, Lithium Sulfide, and LFP.

Embodiment 29: The composition of any one of embodiments 21-28, wherein the separator layer comprises a solid electrolyte material.

Embodiment 30: An electrochemical cell comprising:
an electrode layer including an electrode active material, a conductive additive, and a first binder;
a separator layer including a solid-state electrolyte material and a second binder,
wherein (i) the first binder in the electrode layer and the second binder in the separator layer are the same,
(ii) the electrode layer and the separator layer are in direct contact at an interface,
(iii) a concentration of the first binder in the electrode layer and a concentration of the second binder in the separator layer defines a gradient having a maximum concentration in the separator layer at a furthest point from the interface and a minimum concentration at a point in the electrode layer, and
(iv) the concentration of the first binder in the separator layer at the interface is substantially the same as the concentration of the second binder in the electrode layer at the interface.

Embodiment 31: The electrochemical cell of embodiment 30, wherein the active material is an anode active material comprising one or more of Silicon, Silicon Alloy, Graphite, Lithium, and Lithium alloy.

Embodiment 32: The electrochemical cell of embodiment 30 or 31, wherein the active material is a cathode active material comprising one or more of NMC, Sulfur, Pyrite, Lithium Sulfide, and LFP.

Embodiment 33: An electrochemical cell comprising:
a current collector,
an electrode layer having a first side in operable contact with the current collector and a second side opposite to the first side, the electrode layer including a first binder; and
a separator layer having a first side in direct contact with the second side of the electrode layer and a second side opposite to the first side, the separator layer including a second binder,
wherein (i) the first binder in the electrode layer and the second binder in the separator layer are the same,
(ii) a concentration of the first binder in the electrode layer and a concentration of the second binder in the separator layer defines a gradient having a maximum concentration at the second side of the separator layer and a minimum concentration at a point in the electrode layer, and
(iii) the concentration of the first binder at the first side of the separator layer is substantially the same as the concentration of the second binder at the second side of the electrode layer.

Embodiment 34: A process for making two-sided electrochemical cells comprising:
simultaneously coating a top side and a bottom side of a two-sided surface with first and second wet electrode slurry, respectively; and
simultaneously coating a first and second separator slurry on each of the respective top and bottom coated wet electrode slurry resulting in two parallel regions of wet-on-wet areas of contact between electrode and separator to physically form two neighboring electrochemical cell portions of a solid state battery.

Embodiment 35: The process of embodiment 34, wherein the first and second wet electrode slurry contains one or more of Silicon, Silicon, Alloy, Graphite, Lithium, and Lithium alloy.

Embodiment 36: The process of embodiment 34 or 35, wherein the first and second wet electrode slurry contains one or more of NMC, Sulfur, Pyrite, Lithium Sulfide, and LFP.

Embodiment 37: The process of any one of embodiments 34-36, wherein the first and second separator slurry contains at least one solid electrolyte material.

Embodiment 38: The process of any one of embodiments 34-37, wherein the two-sided surface is a current collector.

Embodiment 39: A product including one or more two-sided electrochemical cells made by:
simultaneously coating a top side and a bottom side of a two-sided surface with first and second wet electrode slurry material, respectively; and
simultaneously coating a first and second separator slurry on each of the respective top and bottom coated wet electrode slurry resulting in two parallel regions of wet-on-wet areas of contact between electrode and separator to physically form two neighboring electrochemical cell portions of a solid state battery.

Embodiment 40: The product of embodiment 39, wherein the first and second wet electrode slurry contains one or more of Silicon, Silicon, Alloy, Graphite, Lithium, and Lithium alloy.

Embodiment 41: The product of embodiment 39 or 40, wherein the first and second wet electrode slurry contains one or more of NMC, Sulfur, Pyrite, Lithium Sulfide, and LFP.

Embodiment 42: The product of any one of embodiments 39-41, wherein the first and second separator slurry contains at least one solid electrolyte material.

Embodiment 43: The product of any one of embodiments 39-42, wherein the two-sided surface is a current collector.

Embodiment 44: A process for making electrochemical cells comprising coating a wet separator slurry on top of a wet electrode slurry, previously coated on a surface, resulting in an initial wet-on-wet contact between an electrode and a separator to define a portion of an electrochemical cell.

Embodiment 45: The process of embodiment 44, wherein the separator slurry comprises a solid electrolyte material.

Embodiment 46: The process of embodiment 45, comprising drying the coated electrode and separator forming an electrode-separator layer.

Embodiment 47: The process of embodiment 46, further comprising laminating the dried electrode-separator layer with a second dried composition to form a complete electrochemical cell.

Embodiment 48: The process of embodiment 47 wherein, the second dried composition is an electrode or electrode-separator layer.

Embodiment 49: The process of embodiment 48 wherein, the second dried composition is a second electrode-separator layer and is made by coating a second wet separator slurry on top of a second wet electrode, previously coated on a second surface, resulting in an initial wet-on-wet contact between the second electrode and the second separator to jointly form an electrochemical cell.

Embodiment 50: The process of embodiment 47, wherein the laminating forms an interface between the electrode-separator layer and the second dried composition.

Embodiment 51: The process of any one of embodiments 44-50, wherein the coating results in the formation of an interface between the electrode and the separator.

Embodiment 52: The process of any one of embodiments 44-51, wherein the electrode comprises a first binder concentration gradient and the separator comprises a second binder concentration gradient.

Embodiment 53: The process of embodiment 52, wherein the first binder concentration gradient and the second binder concentration gradient define a continual binder concentration gradient across an interface between the electrode and the separator.

Embodiment 54: A process for preparing a multilayer electrochemical cell component comprising:
coating an electrode slurry onto a surface;
coating a separator slurry on top of the coated electrode slurry while the electrode slurry is still wet, such that the separator slurry and coated electrode slurry are both wet and in contact;
drying the electrode slurry and the separator slurry to form a dried composition comprising a first electrode layer and a first separator layer; and
densifying the dried composition.

Embodiment 55: The process of embodiment 54, wherein the first electrode layer comprises a first binder concentration gradient and the first separator layer comprises a second binder concentration gradient.

Embodiment 56: The process of embodiment 55, wherein the first binder concentration gradient and the second binder concentration gradient define a continual binder concentration gradient across an interface between the first electrode layer and the first separator layer.

Embodiment 57: A composition comprising:
an electrode layer comprising a first binder concentration gradient;
a separator layer comprising a second binder concentration gradient; and,
a current collector.

Embodiment 58: The composition of embodiment 57, wherein the first binder concentration gradient and second binder concentration gradient define a continual binder concentration gradient across an interface.

Embodiment 59: The composition of embodiment 58, wherein the separator layer is adjacent to the electrode layer, and wherein the continual binder concentration gradient extends from a side of the electrode layer at the current collector through the separator layer and a first binder concentration of the electrode layer is the same as a second binder concentration of the separator layer where the separator layer is adjacent to the electrode layer.

Embodiment 60: The composition of embodiment 58 or 59, wherein the composition comprises a bridging network spanning the interface.

Embodiment 61: The composition of any one of embodiments 57-60, wherein the electrode layer is an anode layer.

Embodiment 62: The composition of embodiment 61, wherein the anode layer comprises a bilayer anode.

Embodiment 63: The composition of any one of embodiments 57-60, wherein the electrode layer is a cathode layer.

Embodiment 64: The composition of embodiment 63, wherein the electrode layer comprises a bilayer cathode.

Embodiment 65: A composition comprising:
an electrode layer comprising:
   an electrode active material;
   a conductive additive;
   a solid-state electrolyte material; and
   a first binder;
a separator layer comprising:
   a solid-state electrolyte material; and
   a second binder,
wherein the first binder in the electrode layer and the second binder in the separator layer are the same,
wherein the electrode layer and the separator layer are in direct contact at an interface,
wherein a concentration of the first binder in the electrode layer and a concentration of the second binder in the separator layer defines a gradient having a maximum concentration in the separator layer at a furthest point from the interface and a minimum concentration at a point in the electrode layer, and
wherein the concentration of the first binder in the separator layer is substantially the same as the concentration of the second binder in the electrode layer at the interface.

Embodiment 66: An electrochemical cell comprising:
a current collector;
an electrode layer having a first side in operable contact with the current collector and a second side opposite to the first side, the electrode layer comprising a first binder; and
a separator layer having a first side in direct contact with the second side of the electrode layer and a second side opposite to the first side, the separator layer comprising a second binder;
wherein the first binder in the electrode layer and the second binder in the separator layer are the same,
wherein a concentration of the first binder in the electrode layer and a concentration of the second binder in the separator layer defines a gradient having a maximum concentration at the second side of the separator layer and a minimum concentration at a point in the electrode layer, and
wherein the concentration of the first binder at the first side of the separator layer is substantially the same as the concentration of the second binder at the second side of the electrode layer.

Embodiment 67: A method of making a solid-state electrochemical cell, the method comprising:
coating an anode layer onto a current collector, wherein the anode layer comprises a binder;
coating a separator layer onto the anode layer before the anode layer has dried, wherein the separator layer comprises a first quantity of the binder; and
drying the separator layer and the anode layer,
wherein the dried separator layer comprises a second quantity of the binder, wherein the second quantity of the binder is greater than the first quantity of the binder.

Embodiment 68: The method of embodiment 67, wherein the binder moves from the anode layer into the separator layer by advection.

Embodiment 69: A process for preparing a multilayer electrochemical cell component comprising:
coating an electrode slurry onto a surface;
coating a separator slurry on top of the coated electrode slurry while the electrode slurry is still wet, such that the separator slurry and coated electrode slurry are both wet and in contact;
drying the electrode slurry and the separator slurry to form a dried composition comprising a first electrode layer and a first separator layer; and
densifying the dried composition.

Embodiment 70: The process of embodiment 69, further comprising laminating the dried composition with a second electrode layer.

Embodiment 71: The process of embodiment 69, further comprising laminating the dried composition with a second dried composition comprising a second electrode layer and a second separator layer.

Embodiment 72: The process of embodiment 71, wherein the laminating forms an interface between the first separator layer and the second separator layer.

Embodiment 73: The process of any one of embodiments 69-72, wherein the coating results in the formation of an interface between the first electrode layer and the first separator layer.

Embodiment 74: The process of any one of embodiments 69-73, wherein the first electrode layer comprises a first binder concentration gradient and the first separator layer comprises a second binder concentration gradient.

Embodiment 75: The process of embodiment 74, wherein the first binder concentration gradient and the second binder concentration gradient define a continual binder concentration gradient across an interface between the first electrode layer and the first separator layer.

Embodiment 76: The process of any one of embodiments 69-75, wherein the dried composition has a porosity from about 70% to about 1%.

Embodiment 77: The process of any one of embodiments 69-76, wherein the electrode slurry has a liquid content from about 10 wt % to about 90 wt %.

Embodiment 78: The process of embodiment 77, wherein the electrode slurry has a liquid content from about 30 wt % to about 70 wt %.

Embodiment 79: The process of any one of embodiments 69-78, wherein the separator slurry has a liquid content from about 10 wt % to about 90 wt %.

Embodiment 80: The process of embodiment 79, wherein the separator slurry has a liquid content from about 30 wt % to about 70 wt %.

Embodiment 81: The process of any one of embodiments 69-80, wherein the electrode slurry has a viscosity from about 20 cP to about 3000 cP as measured at a shear rate of 100 s⁻¹.

Embodiment 82: The process of embodiment 81, wherein the electrode slurry has a viscosity from about 100 cP to about 1000 cP as measured at a shear rate of 100 s⁻¹.

Embodiment 83: The process of any one of embodiments 69-82, wherein the separator slurry has a viscosity from about 20 cP to about 3000 cP as measured at a shear rate of 100 s⁻¹.

Embodiment 84: The process of embodiment 83, wherein the separator slurry has a viscosity from about 20 cP to about 1000 cP as measured at a shear rate of 100 s⁻¹.

Embodiment 85: The process of any one of embodiments 69-84, wherein the dried composition has a density from about 50% to about 99% of the theoretical density after densifying.

Embodiment 86: The process of any one of embodiments 69-85, wherein the densifying comprises calendering.

Embodiment 87: A process comprising:
coating a first electrode slurry onto a first side of a surface and coating a second electrode slurry onto a second side of the surface;
coating a first separator slurry on top of the coated first electrode slurry while the first electrode slurry is still wet, such that the first separator slurry and coated first electrode slurry are both wet and in contact;
coating a second separator slurry on top of the second electrode slurry while the second electrode slurry is still wet, such that the second separator slurry and coated second electrode slurry are both wet and in contact;
drying the slurries to form a dried composition comprising the carrier foil, a first electrode layer, a first separator layer, a second electrode layer, and a second separator layer; and
densifying the dried composition.

Embodiment 88: The process of embodiment 87, further comprising separating the first electrode layer and the second separator layer from the first side of the surface and separating the second electrode layer and the second separator layer from the second side of the surface, thereby forming a first dried composition and a second dried composition, the first dried composition comprising the first electrode layer and the first separator layer, and the second dried composition comprising the second electrode layer and the second separator layer.

Embodiment 89: The process of embodiment 88, further comprising laminating the first dried composition and second dried composition such that the first separator layer and the second separator layer are in operable contact.

Embodiment 90: The process of any one of embodiments 87-89, further comprising cutting the surface to separate the first side of the surface from the second side of the surface, thereby forming a first dried composition and a second dried composition, the first dried composition comprising the first electrode layer, the first separator layer, and the first side of the surface, and the second dried composition comprising the second electrode layer, the second separator layer, and the second side of the surface.

Embodiment 91: The process of embodiment 90, further comprising laminating the first dried composition and second dried composition such that the first separator layer and the second separator layer are in operable contact.

Embodiment 92: The process of any one of embodiments 87-91, wherein the first electrode slurry and the second electrode slurry are coated simultaneously.

Embodiment 93: The process of any one of embodiments 87-92, wherein the first separator slurry and the second separator slurry are coated simultaneously.

Embodiment 94: A process comprising:
coating an electrode slurry onto a carrier foil;
coating a binder slurry on top of the coated electrode slurry while the electrode slurry is still wet, such that the binder slurry and coated electrode slurry are both wet and in contact, the binder slurry comprising a binder;
coating a separator slurry on top of the coated binder slurry;
drying the electrode slurry and the separator slurry to form a dried composition comprising a first electrode layer and a first separator layer; and
densifying the dried composition.

Embodiment 95: A process comprising:
coating an electrode slurry onto a carrier foil;
coating a binder slurry on top of the coated electrode slurry while the electrode slurry is still wet, such that the binder slurry and coated electrode slurry are both wet and in contact, the binder slurry comprising a binder;
coating a separator slurry on top of the coated binder slurry;
drying the electrode slurry and the separator slurry to form a dried composition comprising a first electrode layer and a first separator layer; and
densifying the dried composition

Embodiment 96: A process comprising:
coating a binder slurry onto a carrier foil, the binder slurry comprising a binder;
coating an electrode slurry on top of the coated binder slurry while the binder slurry is still wet, such that the binder slurry and coated electrode slurry are both wet and in contact;
coating a separator slurry on top of the coated electrode slurry while the electrode slurry is still wet;
drying the binder slurry, the electrode slurry and the separator slurry to form a dried composition comprising a first electrode layer and a first separator layer; and
densifying the dried composition.

Embodiment 97: A process for preparing a multilayer electrochemical cell component comprising:
coating an electrode slurry onto a surface;
coating a separator slurry on top of the coated electrode slurry while the electrode slurry is still wet, such that the separator slurry and coated electrode slurry are both wet and in contact;
drying the electrode slurry and the separator slurry to form a dried composition comprising a first electrode layer and a first separator layer; and
densifying the dried composition.

Embodiment 98: The process of embodiment 97, wherein the surface comprises a carrier foil or a current collector.

Embodiment 99: A process for preparing a multilayer electrochemical cell component comprising:
coating an electrode slurry onto a surface;
coating a separator slurry on top of the coated electrode slurry while the electrode slurry is still wet, such that the separator slurry and coated electrode slurry are both wet and in contact;
drying the electrode slurry and the separator slurry to form a dried composition comprising a first electrode layer and a first separator layer; and
densifying the dried composition.

Embodiment 100: A multilayer electrochemical cell component comprising:
(a) an electrode slurry in contact with a carrier foil; and,
(b) a separator slurry in contact with the electrode slurry, wherein the separator slurry and coated electrode slurry are in contact while wet.

Embodiment 101: A process for preparing a multilayer electrochemical cell component comprising:
coating a first electrochemical cell layer slurry onto a surface;
coating a second electrochemical cell layer slurry on top of the coated first electrochemical cell layer slurry while the first electrochemical cell layer slurry is still wet, such that the second electrochemical cell layer slurry and coated first electrochemical cell layer slurry are both wet and in contact;
drying the first electrochemical cell layer slurry and the second electrochemical cell layer slurry to form a dried composition comprising a first electrochemical cell layer and a second electrochemical cell layer; and
densifying the dried composition

Embodiment 102: The process of embodiment 101, further comprising laminating the dried composition with a second electrochemical cell layer.

Embodiment 103: The process of embodiment 101 or 102, further comprising laminating the dried composition with a second dried composition comprising a third electrochemical cell layer and a fourth electrochemical cell layer.

Embodiment 104: The process of embodiment 103, wherein the laminating forms an interface between the second electrochemical cell layer and the third electrochemical cell layer.

Embodiment 105: The process of any one of embodiments 101-104, wherein the coating results in the formation of an interface between the first electrochemical cell layer and the second electrochemical cell layer.

Embodiment 106: The process of any one of embodiments 101-105, wherein the first electrochemical cell layer comprises a first binder concentration gradient and the second electrochemical cell layer comprises a second binder concentration gradient.

Embodiment 107: The process of embodiment 106, wherein the first binder concentration gradient and the second binder concentration gradient define a continual binder concentration gradient across an interface between the first electrochemical cell layer and the second electrochemical cell layer.

Embodiment 108: The process of any one of embodiments 101-107, wherein the dried composition has a porosity from about 70% to about 1%.

Embodiment 109: The process of any one of embodiments 101-108, wherein the first electrochemical cell layer slurry has a liquid content from about 10 wt % to about 90 wt %.

Embodiment 110: The process of embodiment 109, wherein the first electrochemical cell layer slurry has a liquid content from about 30 wt % to about 70 wt %.

Embodiment 111: The process of any one of embodiments 101-110, wherein the second electrochemical cell layer slurry has a liquid content from about 10 wt % to about 90 wt %.

Embodiment 112: The process of embodiment 111, wherein the second electrochemical cell layer slurry has a liquid content from about 30 wt % to about 70 wt %.

Embodiment 113: The process of any one of embodiments 101-112, wherein the first electrochemical cell layer slurry has a viscosity from about 20 cP to about 3000 cP as measured at a shear rate of 100 s⁻¹.

Embodiment 114: The process of embodiment 113, wherein the first electrochemical cell layer slurry has a viscosity from about 100 cP to about 1000 cP as measured at a shear rate of 100 s⁻¹.

Embodiment 115: The process of any one of embodiments 101-114, wherein the second electrochemical cell layer slurry has a viscosity from about 20 cP to about 3000 cP as measured at a shear rate of 100 s⁻¹.

Embodiment 116: The process of embodiment 115, wherein the second electrochemical cell layer slurry has a viscosity from about 20 cP to about 1000 cP as measured at a shear rate of 100 s⁻¹.

Embodiment 117: The process of any one of embodiments 101-116, wherein the dried composition has a density from about 50% to about 99% of the theoretical density after densifying.

Embodiment 118: The process of any one of embodiments 101-117, wherein the densifying comprises calendering.

Embodiment 119: A composition comprising:
an electrode layer comprising a first binder concentration gradient;
a separator layer comprising a second binder concentration gradient; and,
a current collector.

Embodiment 120: The composition of embodiment 119, wherein the first binder concentration gradient and second binder concentration gradient define a continual binder concentration gradient across an interface.

Embodiment 121: The composition of embodiment 120, wherein the separator layer is adjacent to the electrode layer, and wherein the continual binder concentration gradient extends from a side of the electrode layer at the current collector through the separator layer and a first binder concentration of the electrode layer is the same as a second binder concentration of the separator layer where the separator layer is adjacent to the electrode layer.

Embodiment 122: The composition of embodiment 120 or 121, wherein the composition comprises a bridging network spanning the interface.

Embodiment 123: The composition of any one of embodiments 119-122, wherein the electrode layer is an anode layer.

Embodiment 124: The composition of embodiment 123, wherein the anode layer comprises a bilayer anode.

Embodiment 125: The composition of any one of embodiments 119-122, wherein the electrode layer is a cathode layer.

Embodiment 126: The composition of embodiment 125, wherein the electrode layer comprises a bilayer cathode.

Embodiment 127: A composition comprising:
an electrode layer comprising:
   an electrode active material;
   a conductive additive;
   a solid-state electrolyte material; and
   a first binder;
a separator layer comprising:
   a solid-state electrolyte material; and
   a second binder,
wherein the first binder in the electrode layer and the second binder in the separator layer are the same,
wherein the electrode layer and the separator layer are in direct contact at an interface,
wherein a concentration of the first binder in the electrode layer and a concentration of the second binder in the separator layer defines a gradient having a maximum concentration in the separator layer at a furthest point from the interface and a minimum concentration at a point in the electrode layer, and
wherein the concentration of the first binder in the separator layer is substantially the same as the concentration of the second binder in the electrode layer at the interface.

Embodiment 128: An electrochemical cell comprising:
a current collector,
an electrode layer having a first side in operable contact with the current collector and a second side opposite to the first side, the electrode layer comprising a first binder; and
a separator layer having a first side in direct contact with the second side of the electrode layer and a second side opposite to the first side, the separator layer comprising a second binder,
wherein the first binder in the electrode layer and the second binder in the separator layer are the same,
wherein a concentration of the first binder in the electrode layer and a concentration of the second binder in the separator layer defines a gradient having a maximum concentration at the second side of the separator layer and a minimum concentration at a point in the electrode layer, and
wherein the concentration of the first binder at the first side of the separator layer is substantially the same as the concentration of the second binder at the second side of the electrode layer.

Embodiment 129: A method of making a solid-state electrochemical cell, the method comprising:
coating an anode layer onto a current collector, wherein the anode layer comprises a binder;
coating a separator layer onto the anode layer before the anode layer has dried, wherein the separator layer comprises a first quantity of the binder; and
drying the separator layer and the anode layer,
wherein the dried separator layer comprises a second quantity of the binder, wherein the second quantity of the binder is greater than the first quantity of the binder.

Embodiment 130: The method of embodiment 129, wherein the binder moves from the anode layer into the separator layer by advection.

Embodiment 131: The method of embodiment 129 or 130, wherein the first quantity of the binder is less than 1% by weight of the separator layer.

Embodiment 132: The method embodiment 131, wherein the first quantity of the binder is less than 0.1% by weight of the separator layer.

Embodiment 133: A composition comprising:
an electrode layer comprising:
   an electrode active material;
   a conductive additive;
   a solid-state electrolyte material; and
   a first binder;
a separator layer comprising:
   a solid state electrolyte material; and
   a second binder,
wherein the first binder in the electrode layer and the second binder in the separator layer are the same,
wherein the electrode layer and the separator layer are in direct contact with each other at an interface,
wherein a concentration of the first binder in the electrode layer is ±5% or less by weight the concentration of the second binder in the separator layer at the interface.

Embodiment 134: The composition of embodiment 133, wherein the concentration of the first binder in the electrode layer is ±4% or less, ±3% or less, ±2% or less, ±1% or less, ±0.5% or less, ±0.3% or less, ±0.1% or less, or ±0.05% or less by weight the concentration of the second binder in the separator layer at the interface.

Embodiment 135: A method of preparing a solid-state electrode, the method comprising:
contacting a surface of an electrode layer comprising a first set of one or more particles with a surface of a separator layer comprising a second set of one or more particles to create a particle interface; and
migrating the first set or second set across the particle interface to produce a particle gradient.

Embodiment 136: The method of embodiment 135, wherein the particle gradient is visible under SEM as physical connections across the particle interface.

Embodiment 137: The method of embodiment 136, where the physical connections are between binder particles.

Embodiment 138: The method of any one of embodiments 135-137, wherein the binder particles comprise styrene-ethylene-butylene-styrene block copolymer (SEBS).

Embodiment 139: A method of increasing adhesion between a solid-state electrode and a separator layer, the method comprising:
contacting a surface of an electrode layer comprising a first set of one or more particles with a surface of a separator layer comprising a second set of one or more particles to create a particle interface; and
migrating the first set or second set across the particle interface to produce a particle gradient.

Embodiment 140: The method of embodiment 139, wherein the particle gradient is visible under SEM as physical connections across the interface.

Embodiment 141: The method of embodiment 140, where the physical connections are between binder particles.

Embodiment 142: The method of embodiment 141, wherein the binder particles comprise styrene-ethylene-butylene-styrene block copolymer (SEBS).

Embodiment 143: The method of any one of embodiments 139-142, further comprising pressing the electrode layer and the separator layer together.

Embodiment 144: The method of any one of embodiments 139-143, further comprising laminating the electrode layer and the separator layer together.

Embodiment 145: A method of producing layers for use in a solid-state electrochemical cell; the method comprising:
depositing two or more layers in close proximity to one another, each layer comprising one or more solvent;
increasing a surface-to-surface contact of at least one layer to a second layer to produce a surface interface; and
substantially removing the one or more solvent.

Embodiment 146: A method of producing solid-state electrode layers; the method comprising:
producing a first layer and a second layer in slurry form, each layer comprising one or more solvents;
coating the first layer onto a carrier foil or current collector;
coating the second layer onto the carrier foil or current collector in close proximity to the first layer;
increasing a surface-to-surface contact of the first layer and the second layer; and, substantially removing the one or more solvents.

Embodiment 147: The method of embodiment 146, wherein the one or more solvents comprises a dissolved binder.

Embodiment 148: The method of embodiment 146 or 147, further comprising generating a capillary effect through the first and second electrode layer.

Embodiment 149: The method of any one of embodiments 146-148, wherein the removal of the one or more solvents comprises drying.

Embodiment 150: The method of any one of embodiments 146-149, further comprising incorporating the dried layers into a battery.

Embodiment 151: The method of embodiment 150, wherein all layers in the battery comprise solid-to-solid interfaces.

Embodiment 152: The method of any one of embodiments 146-149, wherein the first layer is an electrode layer.

Embodiment 153: The method of embodiment 152, wherein the electrode layer is an anode layer.

Embodiment 154: The method of embodiment 153, wherein the anode layer comprises silicon.

Embodiment 155: The method of embodiment 152, wherein the electrode layer is a cathode layer.

Embodiment 156: The method of any one of embodiments 146-155, wherein the second layer is a separator layer.

Embodiment 157: The method of embodiment 156, wherein the separator layer has between about 0% to about 50% of binder.

Embodiment 158: The method of embodiment 157, wherein the separator layer has between about 0% to about 30% of binder.

Embodiment 159: The method of embodiment 157, wherein the separator layer has between about 0% to about 10% of binder.

Embodiment 160: The method of embodiment 157, wherein the separator layer has between about 0% to about 5% of binder.

Embodiment 161: The method of embodiment 157, wherein the separator layer has between about 0% to about 1% of binder.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1

A coating was made according to the methods of the present disclosure. A cathode layer including a NMC cathode active material, SEBS, and N935, without any carbon additive was coated onto a current collector. While the cathode layer was still wet, a binder-free separator layer including a sulfide-based solid electrolyte material dissolved in isobutyl isobutyrate was coated on top of the cathode layer. The cathode/separator stack was dried to remove the solvents and then laminated.

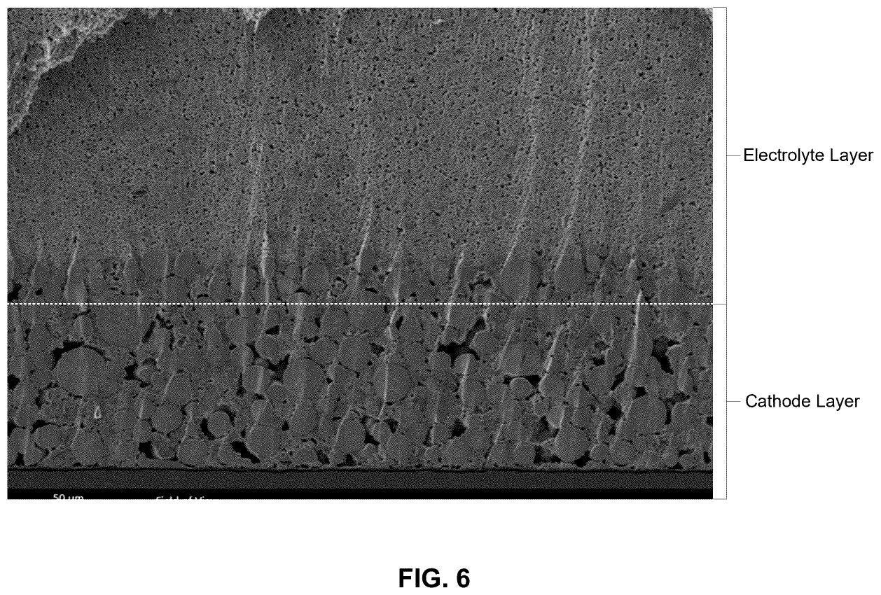

An SEM image of the stack is provided in FIG. 6. As can be seen, the porosity within the cathode layer appears to be lower above the red dotted line (section A) as compared to the section below the dotted line (section B). It is hypothesized that there may be lower porosity in the electrolyte layer at regions close to the cathode/electrolyte interface as compared to the regions closer to the carrier foil (top of FIG. 6).

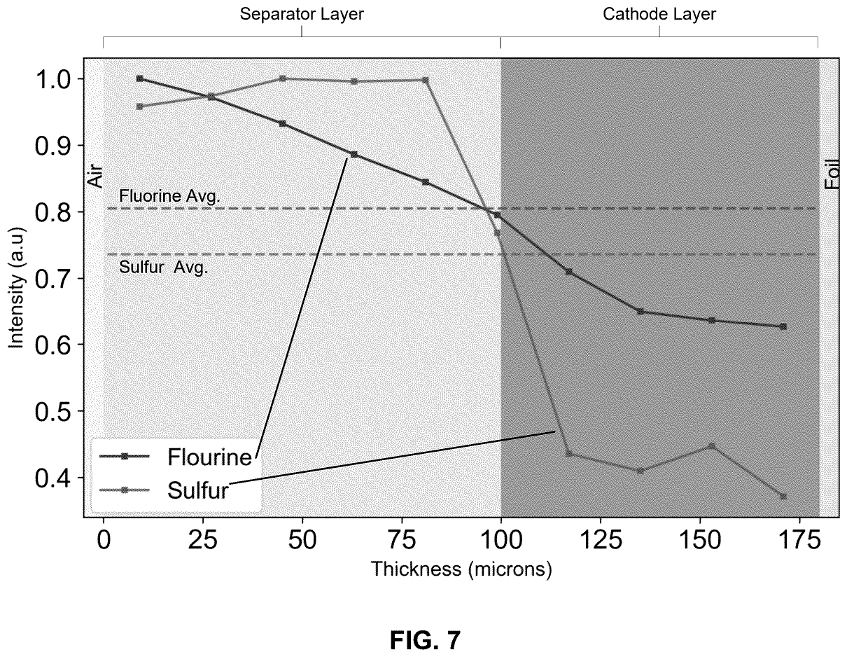

An elemental map of the SEM image in FIG. 6 is shown in FIG. 7. The only binder used in the stack was one that contained fluorine and, as coated, the separator layer was binder-free. From this elemental analysis, a gradual increase in the fluorine content from right to left (i.e., from the cathode to the separator layer) can be seen. This shows that the binder contained in the cathode layer migrated towards and into the Separator layer forming a continuous binder gradient across the interface of these two layers.

### Example 2

An anode layer containing 10% SEBS, a solid-state electrolyte material, silicon, and a solvent was coated onto a current collector. A separator layer containing only a solid-state electrolyte material and a solvent (i.e., 0% binder) was cast directly on top of the anode layer. The two wet layers were then dried.

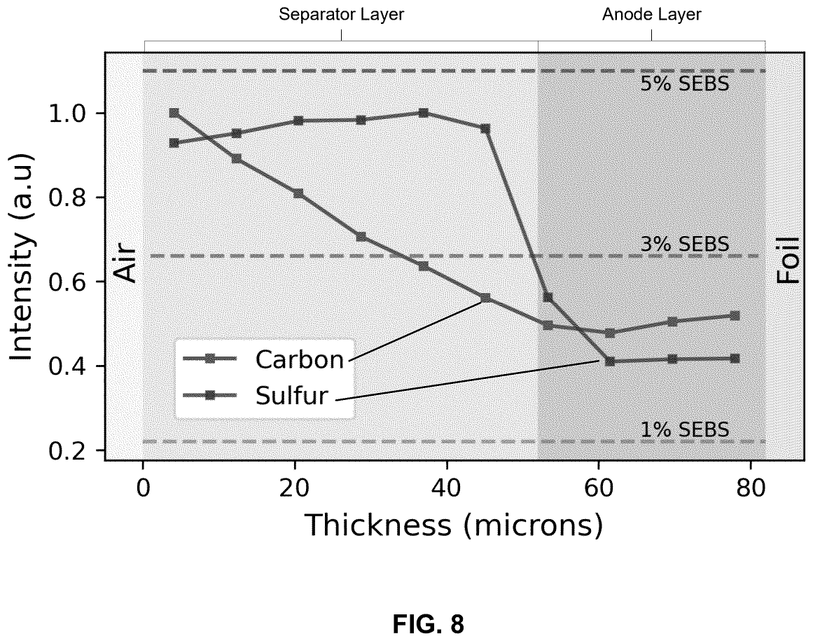

The resulting composition is shown FIG. 5, imaged by SEM. EDS mapping of the composition was also conducted, the results for which are shown in FIG. 8. EDS mapping showed the concentration of carbon and sulfur through the composition. The right region of the chart represents the anode layer, and the left region of the chart represents the separator layer. Starting from the top of the separator (i.e., the point of the separator layer farthest from the current collector), the concentration of the carbon gradually increases due to the increase in binder concentration. FIG. 8 shows that the separator layer has a greater binder concentration than the anode layer, even though the separator layer did not contain any binder when the separator layer slurry was cast. Therefore, the binder from the anode layer migrated into the separator layer.

### Example 3

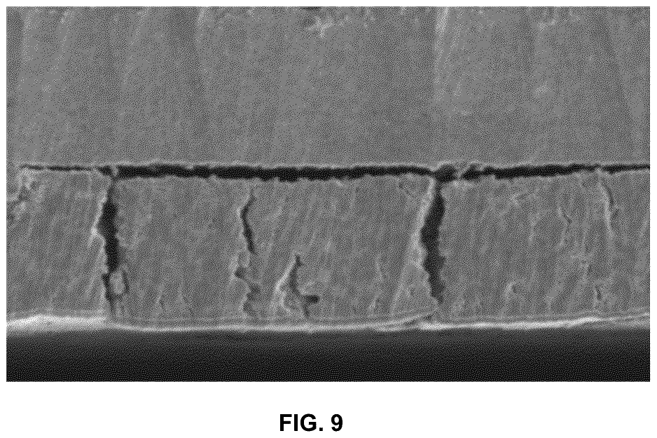

As a comparison, an anode layer and a separator layer were separately cast and dried. Traditional lamination techniques were used to combine the layers to form an electrochemical cell composition, which was then cycled. An SEM image of the composition after cycling is shown in FIG. 9. After cycling, cracks were formed between the anode layer and the separator layer.

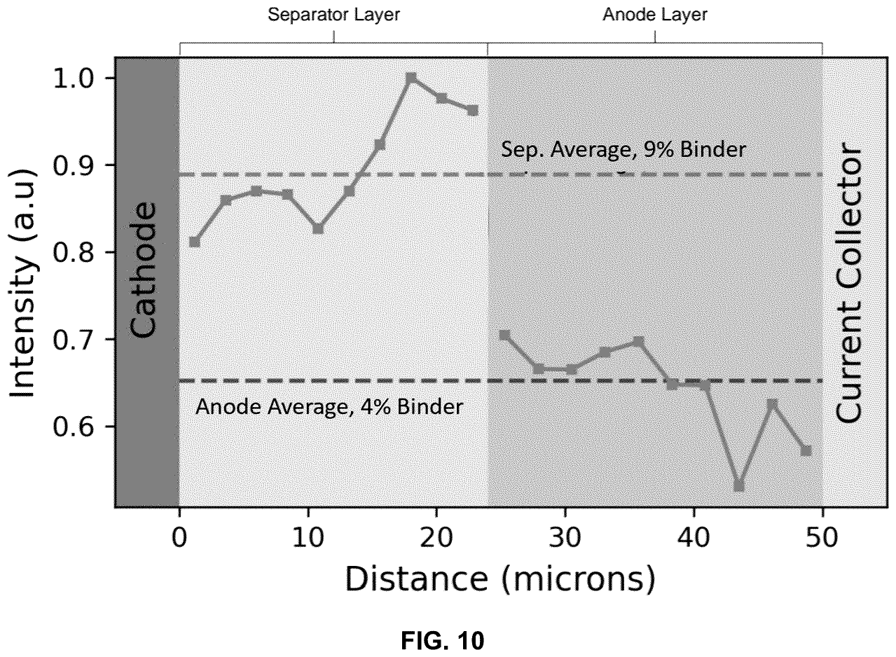

The electrochemical cell was also analyzed using EDS mapping, the results of which are shown in FIG. 10. The EDS mapping showed the concentration of carbon through the length of the anode layer (right) and the separator layer (left). The results show that binder gradients formed in each of the individual cathode and separator layers when they were separately cast and dried. This can be seen in FIG. 10 as the concentration of carbon gradually increases from the current collector to the anode/separator interface, and from the cathode to the anode/separator interface. However, unlike the compositions of the present disclosure, there is a large discontinuity in the carbon concentration at the anode/separator interface.

### Example 4

An anode layer containing 2-8 wt % binder (SEBS), a solid-state electrolyte material, silicon, and a solvent was coated onto a current collector. A separator layer containing only solid-state electrolyte material and solvent (5% binder) was cast directly on top of the anode layer. The two wet layers were then dried.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A process for making two-sided electrochemical cells comprising:
simultaneously coating a top side and a bottom side of a two-sided surface with first and second wet electrode slurry, respectively; and
simultaneously coating a first and second separator slurry on each of the respective top and bottom coated wet electrode slurry resulting in two parallel regions of wet-on-wet areas of contact between electrode and separator to physically form two neighboring electrochemical cell portions of a solid state battery.

2. The process of claim 1, wherein the first and second wet electrode slurry contains one or more of Silicon, Silicon, Alloy, Graphite, Lithium, and Lithium alloy.

3. The process of claim 1, wherein the first and second wet electrode slurry contains one or more of NMC, Sulfur, Pyrite, Lithium Sulfide, and LFP.

4. The process of claim 1, wherein the first and second separator slurry contains at least one solid electrolyte material.

5. The process of claim 1, wherein the two-sided surface is a current collector.

6. A product including one or more two-sided electrochemical cells made by:
simultaneously coating a top side and a bottom side of a two-sided surface with first and second wet electrode slurry material, respectively; and
simultaneously coating a first and second separator slurry on each of the respective top and bottom coated wet electrode slurry resulting in two parallel regions of wet-on-wet areas of contact between electrode and separator to physically form two neighboring electrochemical cell portions of a solid state battery.

7. The product of claim 6, wherein the first and second wet electrode slurry contains one or more of Silicon, Silicon, Alloy, Graphite, Lithium, and Lithium alloy.

8. The product of claim 6, wherein the first and second wet electrode slurry contains one or more of NMC, Sulfur, Pyrite, Lithium Sulfide, and LFP.

9. The product of claim 6, wherein the first and second separator slurry contains at least one solid electrolyte material.

10. The product of claim 6, wherein the two-sided surface is a current collector.
